(19) United States
(12) Patent Application Publication
(10) Pub. No.: US 2018/0231141 A1
(43) Pub. Date: Aug. 16, 2018

(54) Lockable Valve

(71) Applicant: NINGBO TEXOON BRASSWORKS CO.,LTD, Ningbo (CN)

(72) Inventors: Zhenhua FENG, Ningbo (CN); Xizhong WANG, Ningbo (CN)

(21) Appl. No.: 15/882,985

(22) Filed: Jan. 29, 2018

(30) Foreign Application Priority Data
Feb. 11, 2017 (CN) 2017110657634
Feb. 11, 2017 (CN) 2017214484926

(51) Int. Cl. F16K 35/02; F16K 5/06; F16K 31/60

(52) U.S. Cl. CPC F16K 35/027; F16K 31/60; F16K 5/0647

(57) ABSTRACT

A lockable valve, includes: a tube body, wherein the tube body further comprises at least two opening ends and a valve end, wherein the valve end is positioned between the at least two opening ends; a rotating valve, wherein the rotating valve is disposed in the tube body for controlling a fluid flowing through the at least two opening ends of the tube body; and a locking arrangement, wherein the locking arrangement is arranged on the rotating valve to limit rotation of the rotating valve between a stopping state and a moving state, wherein when the rotating valve is in the stopping state, the rotating valve is blocked to be moved, wherein when the rotating valve is in the rotating state, the rotating valve is unlocked to be moved to adjust the flowing condition of the fluid in the tube body.

### CROSS REFERENCE OF RELATED APPLICATION

This is a non-provisional application that claims the benefit of priority under 35 U.S.C. § 119 to a China application, application number CN 2017110657634, filed Feb. 11, 2017, and the benefit of priority under 35 U.S.C. § 119 to a China application, application number CN 2017214484926, filed Feb. 11, 2017, which are incorporated herewith by references in their entities.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a valve switching, and more particularly to a valve with locking mechanism.

### Description of Related Arts

In daily life, the valve is commonly used in water pipes, air pipes and flowing pipeline of mist or liquid and so on. The valve is capable to switch between open and close the pipeline to let the fluid pass through or stop out. Also the leakproofness of the valve relates to the pressure of the fluid or the pressure of the pipeline and other problems.

Stability has been an important characteristics that is always to be pursuing in application and production. Since the integrity of the pipeline compared to the valve is not at same level, improving the stability of the fluid path is generally focused on the valve. The traditional valve is mainly to be designed focused on ball valves and sealing rings. But the cost of the design itself is very expensive, and less consideration on production costs, precision, yield and other requirements in manufacturing. And considering of the stability of the valve, most risks exists in manual operation.

In consideration of manual operation to control the traditional valve, mostly it is an accidental operation which leads to change the state of the valve. And because of the traditional ball valve has been capable to realize turning open to close in an infinitely variable way which is smoothly controllable from completely open to completely close the fluid path. However, the traditional valve has no additional manners to protect, unlike the protections of electrical mechanism. Therefore, the traditional valve is very easy to be misused to switch states of the fluid path. In standard of construction, it is dangerous not to follow the order as required to change rate of flowing fluid.

For example, in a case of maintenance of the pipeline, the traditional valve is required to be normally closed. But, on the one hand, it is not need a lot of effort to turn the valve, which can provide a way in large torque to operate. On the other hand, the internal fluid force also has possibility to turn the valve without external operation. There is a common situation that the traditional valve needed to be normally closed during maintenance. But somebody can turn the traditional valve when coming and going, even leading to completely open. Or there is a tendency to open a little to become larger by the pressure of the flowing fluid. As the pressure of the fluid suddenly becomes larger, the traditional valve may to broken to open. Then, security of the maintenance has a great threat. In some construction or rules, the state of the traditional valve must have someone taking care for security.

In day life, there is similar situation that had in family, such as accidentally closed by children, leading to burn the empty in water heater. Another situation is that leaving the house for a long time, and the traditional valve has been completely closed. But because of changeable pressure of the water in pipeline, the traditional valve can be flushed to be opened and increase the risk of leakage of water.

In order to solve problems and alike above, the traditional valve will add another protective device, a shell or multiple switches. Even more, if confirmed there will not be further operation, the wrench of the traditional valve is detached and received, which has external steps and trouble. The market is calling for a valve that is lockable, low cost, and convenient for both producer and user.

### SUMMARY OF THE PRESENT INVENTION

The invention is advantageous in that it provides a lockable valve, which is capable of controlling the flowing state of the fluid in a tube body, wherein the lockable valve comprises a rotating valve which is lockable to change the flowing state of the fluid.

Another advantage of the invention is to provide a lockable valve, wherein the rotating valve is capable of maintaining the flowing state for avoiding accidental operation or unstably pressure change of the fluid influencing the state of the rotating valve.

Another advantage of the invention is to provide a lockable valve, which further comprises a locking arrangement which is capable of locking the position of the rotating valve, so as to ensure the flowing state of the fluid in open or close to keep stability of the lockable valve.

Another advantage of the invention is to provide a lockable valve, wherein the rotating valve has two states, a stopping state and a moving state. When the rotating valve is in the stopping state, the rotating valve cannot be operated to rotate. When the rotating valve is in the moving state, the rotating valve is capable to be operated to rotated, so as to lock the position of the rotating valve whatever the flowing state of the fluid is open or close for providing multiple stable states of the flowing state.

Another advantage of the invention is to provide a lockable valve, wherein the locking arrangement is disposed with the rotating valve to change the relative positions of the rotating valve therein for providing simply operation without influencing the switch function of the rotating valve.

Another advantage of the invention is to provide a lockable valve, wherein the rotating valve is in the stopping state by the locking arrangement, the locking arrangement is in a stopping area which is capable of being further limited to moving for preventing operating the locking arrangement by mistake and negative result of shaking of the rotating valve.

Another advantage of the invention is to provide a lockable valve, wherein as the locking arrangement is unlocked with the rotating valve, the locking arrangement is in a rotating area which is rotatable for operation.

Another advantage of the invention is to provide a lockable valve, wherein the relative positions of the rotating valve is adjustable by the locking arrangement to change states of the rotating valve in the stopping state and the moving state.

Another advantage of the invention is to provide a lockable valve, wherein the locking arrangement limits the position of the rotating valve so as to avoid moving the rotating valve by the pressure of the fluid, and the locking arrangement is limited the movement of the rotating valve out of the fluid to sustain the position of the rotating valve.

Another advantage of the invention is to provide a lockable valve, wherein there is at least two steps for unlocking the locking arrangement to the rotating valve, so as to reduce possibility of unlocking the locking arrangement and removing the stopping state of the rotating valve for cushioning the disoperation.

Another advantage of the invention is to provide a lockable valve, wherein the locking arrangement is manufacturing accordingly to the rotating valve for providing insurance of sealing the rotating valve to reduce influence of disturbing opening and closing.

Another advantage of the invention is to provide a lockable valve, wherein the rotating valve is lockable by the locking arrangement without increasing abrasion to have longer serve life of the rotating valve and reduce the chance of loosening.

Another advantage of the invention is to provide a lockable valve, wherein the position of the rotating valve controlling the fluid is identified and the locking arrangement does not affect the identification.

Another advantage of the invention is to provide a lockable valve, wherein the locking arrangement is protected by the rotating valve to reduce the possibility of damage and erosion and enhance the reliability of the locking arrangement.

Another advantage of the invention is to provide a lockable valve, wherein it is convenient for detaching and repairing the rotating valve without additional complexity.

Another advantage of the invention is to provide a lockable valve, wherein whether the stopping state or the moving state of the rotating valve is in is identified in advance.

Additional advantages and features of the invention will become apparent from the description which follows, and may be realized by means of the instrumentalities and combinations particular point out in the appended claims.

According to the present invention, the foregoing and other objects and advantages are attained by a lockable valve, comprising:

a tube body, wherein the tube body further comprises at least two opening ends and a valve end, wherein the valve end is positioned between the at least two opening ends;

a rotating valve, wherein the rotating valve is disposed in the tube body for controlling a fluid flowing through the at least two opening ends of the tube body; and

a locking arrangement, wherein the locking arrangement is arranged on the rotating valve to limit rotation of the rotating valve between a stopping state and a moving state, wherein when the rotating valve is in the stopping state, the rotating valve is blocked to be moved, wherein when the rotating valve is in the rotating state, the rotating valve is unlocked to be moved to adjust the flowing condition of the fluid in the tube body.

According to one embodiment of the invention, the locking arrangement is arranged on the rotating valve against the tube body.

According to one embodiment of the invention, the locking arrangement further comprises a valve coupler, a driving coupler and a mover, wherein the valve coupler and the driving coupler are movable relatively against each other by the mover to change the distance between the valve coupler and the driving coupler.

According to one embodiment of the invention, the valve end further comprises a receiving portion and a connecting portion, wherein the receiving portion is adapted to be mounted the rotating valve therein, wherein the connecting portion is extended integrally from the receiving portion.

According to one embodiment of the invention, the rotating valve further comprises a main body, a driving handle and a fastening arrangement, wherein the main body is mounted in the valve end by the fastening arrangement, wherein the driving handle is mounted on the main body by the fastening arrangement to be rotated to drive the main body to control the fluid in the tube body.

According to one embodiment of the invention, the main body is positioned in the receiving portion of the valve end.

According to one embodiment of the invention, the main body further comprises a ball valve and two ball seats, wherein the ball seats are communicably disposed on the two ends of the valve ball.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a lockable valve according to a first preferred embodiment of the present invention.

FIG. 2A and 2B are explosive views of the lockable valve according to the first preferred embodiment of the present invention.

FIG. 3 is a cross-sectional view of the lockable valve according to the first preferred embodiment of the present invention.

FIG. 4A and 4B are perspective views of the lockable valve in the moving state and the stopping state according to the first preferred embodiment of the present invention.

FIG. 5A and 5B are perspective views of the lockable valve in the stopping state and the stopping state according to the first preferred embodiment of the present invention.

FIG. 5C and 5D are perspective views of the lockable valve according to the first preferred embodiment of the present invention.

FIG. 6A is an explosive view of the lockable valve according to the second preferred embodiment of the present invention.

FIG. 6B is a perspective view of a lockable valve according to the second preferred embodiment of the present invention.

FIG. 7 is a sectional view of the lockable valve according to the second preferred embodiment of the present invention.

FIG. 8 is a perspective view of the lockable valve in the locked state according to the second preferred embodiment of the present invention.

FIG. 9 is a perspective view of the lockable valve in the unlocked state according to the third preferred embodiment of the present invention.

FIG. 10 is a perspective view of the lockable valve according to the third preferred embodiment of the present invention.

FIG. 11 is a perspective view of the lockable valve in the locked state according to the third preferred embodiment of the present invention.

FIG. 12A and 12B are perspective views of the lockable valve according to the fourth preferred embodiment of the present invention.

FIG. 13 is a sectional view of the lockable valve according to the fourth preferred embodiment of the present invention.

FIG. 14 is a perspective view of the lockable valve according to the fourth preferred embodiment of the present invention.

FIG. 15 is a sectional view of the lockable valve according to the fourth preferred embodiment of the present invention.

FIG. 16 is a perspective view of the lockable valve according to the fourth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

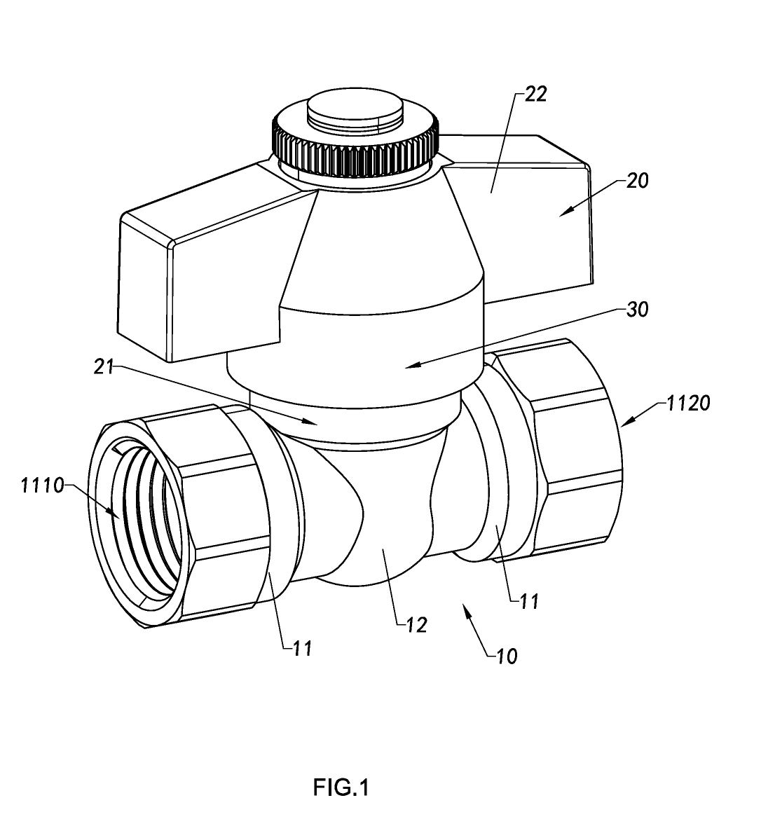

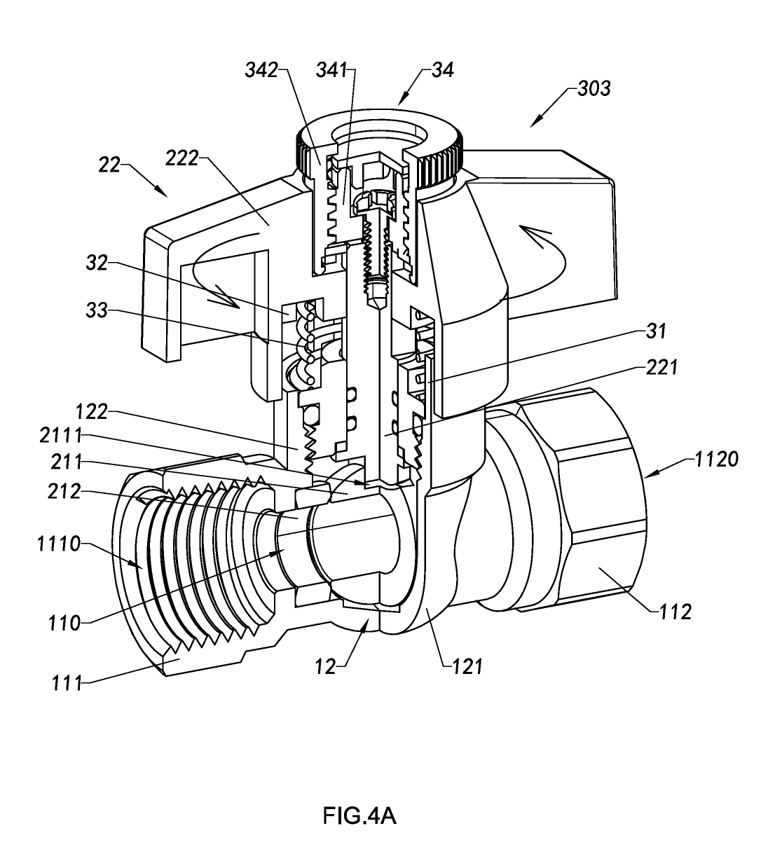

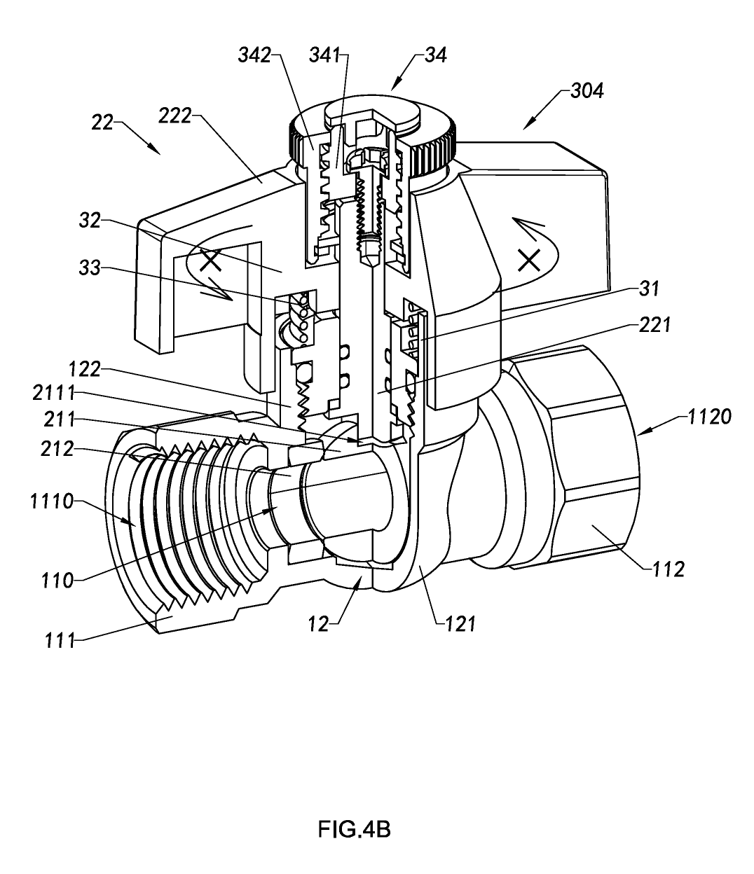

The present invention provides a lockable valve which is illustrated in FIG. 1 to FIG. 5C as a first embodiment of the invention. The lockable valve comprises a tube body 10, a rotating valve 20, and a locking arrangement 30, wherein the rotating valve 20 is embedded in the tube body 10, wherein the locking arrangement 30 is disposed within the tube body 10 and the locking arrangement 30 to control movement between the tube body 10 and the rotating valve 20. The tube body 10 is adapted for flowing a fluid therein and operatable to be opened or closed by moving the rotating valve 20, so as to control moving or stopping of the fluid. The locking arrangement 30 further limits the movement of the rotating valve 20 on the result of moving the rotating valve 20 to operate. In other words, the movement of the rotating valve 20 is limitable by the locking arrangement 30. And operation of the locking arrangement 30 do not have an influence on opening or closing of the tube body 10 by operating the rotating valve 20.

Generally, the fluid is leaded by the tube body 10 which allows the fluid passing in. For the tube body 10, the rotating valve 20 is rotatable to control the fluid is passing the tube body 10 or not to realize the open or close of the rotatable valve. One skills in the art will understand that open or close is not completely conducting or sealing which also has states of transition between the opening and closing of the tube body 10. For convenience of explanation, the move to actively increase flowing of the fluid is defined as opening. The move to reduce flowing of the fluid is defined as closing. Therefore, the movement of the locking arrangement 30 operating to the rotating valve 20 has two states: a moving state 303 and a stopping state 304. As in the moving state 303, the rotating valve 20 is capable of moving to operate the tube body 10 from opening to closing or from closing to opening. The locking arrangement 30 is unlocked to limit the rotating valve 20. As in the stopping state 304, the rotating valve 20 cannot control the tube body 10 and is limited to be operated form opening to closing or from closing to opening.

In other words, with relative to the state of controlling the fluid by the rotating valve, the locking arrangement 30 is focus on controlling the movement of the rotating valve 20. In a design for locking, it is adaptable to stabilize the states of the lockable valve. For example, the rotating valve 20 controls the fluid to be stopped and closed in the tube body 10. The locking arrangement 30 is operated to limit the movement of the rotating valve 20. As the rotating valve 20 is relatively closed with the tube body 10, the rotating valve 20 is stay in being closed with respect to the rotating valve 20 which cannot be operated actively or passively and need to be unlocked by the locking arrangement 30 to be movable. For example, the rotating valve 20 controls the fluid to be in a predetermined flow rate in the tube body 10 and the rotating valve 20 is relatively closed with the tube body 10 which cannot be operated actively or passively and need to be unlocked by the locking arrangement 30 to be movable.

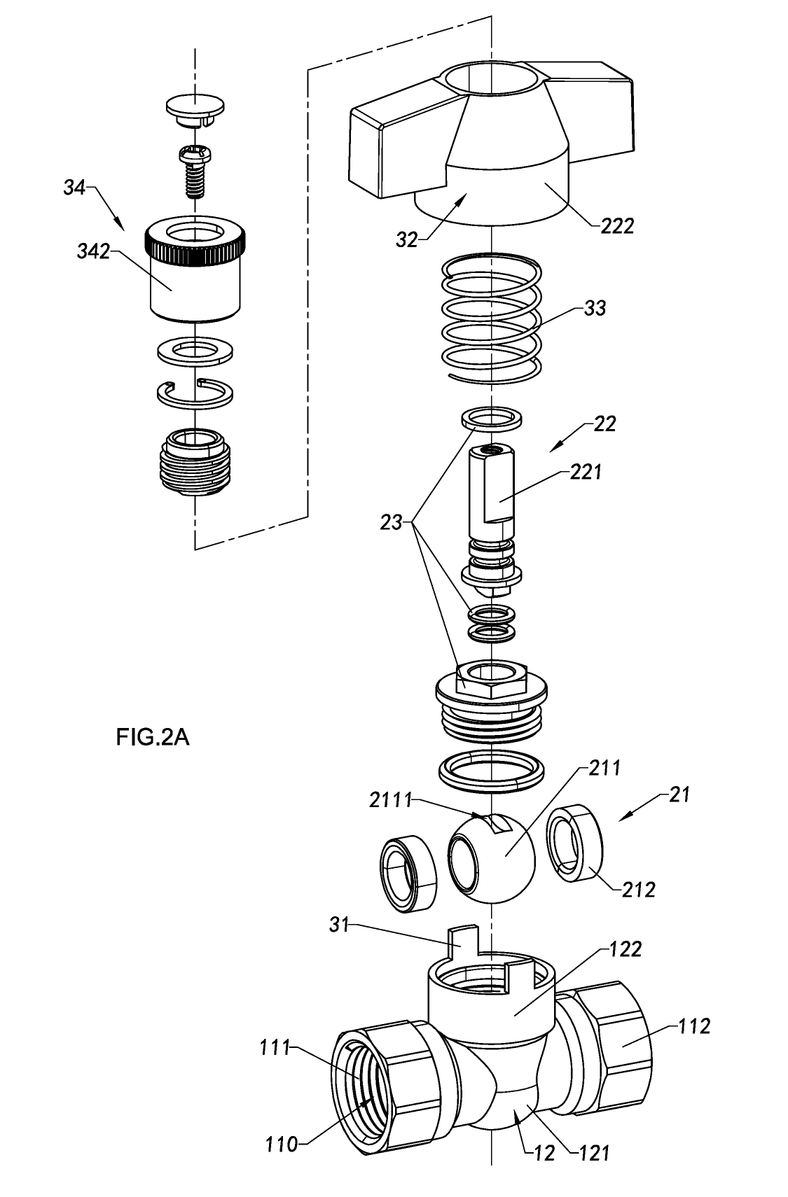

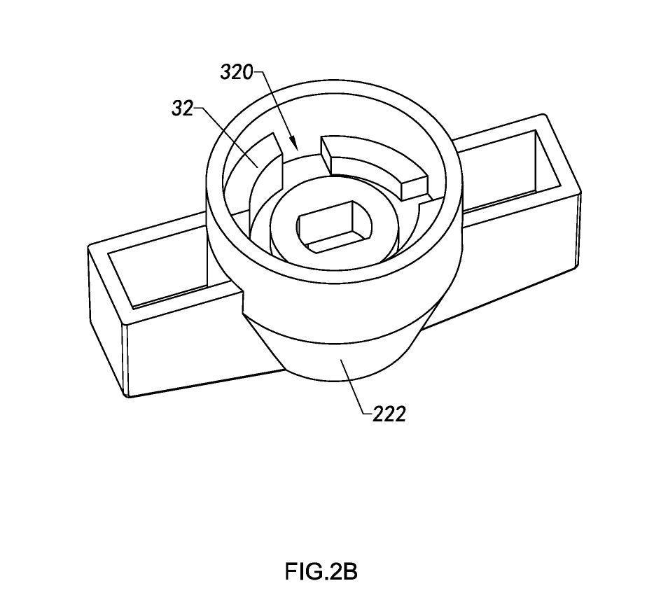

In detail, the tube body 10, the rotating valve 20 and the locking arrangement 30 are illustrated in FIG. 1 and FIG. 2A and 2B. The tube body 10 further comprises at least two opening ends 11 and a valve end 12, wherein the valve end 12 is disposed between the at least two opening ends 11. Each two of the opening ends 11 are communicably connected for the fluid flowing through one of the opening end 11 to the other opening ends 11. The rotating valve 20 is disposed in the valve end 12 and received in the valve end 12 to relatively mounted between the opening ends 11. The rotating valve 20 controls the fluid between the opening ends 11. According to the embodiment, the rotating valve 20 is adapted to control the fluid about the amount or rate of flowing, so as to control the fluid in different kinds of amount degree from closing to opening.

The locking arrangement 30 is disposed between the rotating valve 20 and the valve end 12 of the tube body 10. The locking arrangement 30 limited the position of the rotating body 20 and the valve end 12. In other words, the rotating valve 20 is in the moving state 303 which is capable of changing position between the valve end 12. The rotating valve 20 is in the stopping state 304 which is not capable of changing position between the valve end 12. Further, when the locking arrangement 30 is unlocked, the rotating valve 20 is capable to change position of the valve end 12. And the rotating valve 20 is capable of controlling the fluid between the two opening ends 11. When the locking arrangement 30 is locked up, the rotating valve 20 is not capable to change position of the valve end 12. And the rotating valve 20 is not capable of controlling the fluid between the two opening ends 11.

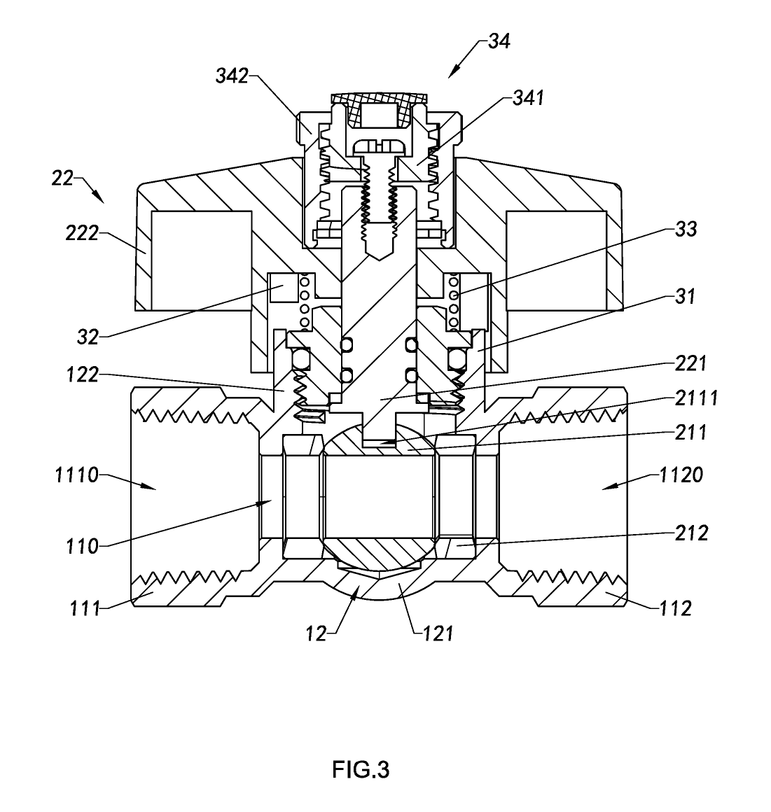

What is more, as shown in FIG. 3, the opening end 11 further comprises a first end 111 and a second end 112, wherein the first end 111 and the second end 112 are both in tubular shape. And the first end 111 and the second end 112 are communicably connected with the valve end 12. According to the embodiment, the first end 111 and the second end 112 is collinearly connected to each other through the valve end 12. The first end 111 has a first opening 110, and the second end 112 has a second opening 1120. The fluid is flowing from the first opening 110 of the first end 111 through the valve end 12 to the second opening 1120 of the second end 112.

One skilled in the art will understand that the first end 111 and the second end 112 can be preset in a predetermined angle. In other words, according to the embodiment of the present invention, it is illustrated the spirit of the invention in a straight pipe which is also can be achieved by corner structure of the pipe.

As shown in FIG. 2B and FIG. 3, the valve end 12 further comprises a receiving portion 121 and a connecting portion 122, wherein the receiving portion 121 is adapted to receive the rotating valve 20 partly therein, wherein the connecting portion 122 is extended integrally from the receiving portion 121. The connecting portion 122 is adapted to be engaged with the rotating valve 20 to be operated. In other words, the receiving portion 121 is received the part of the rotating valve 20 and the connecting portion 122 is connected with the part to operate of the rotating valve 20. The receiving portion 121 is designed according to the size of the rotating valve 20, so as to allow the fluid flowing through the rotating valve 20 to pass through without permeating between the rotating valve 20 and the receiving portion 122 of the valve end 12. The first end 111 and the second end 112 further form a flowing channel 110 therebetween. As the rotating valve 20 is opened, the flowing channel 110 is opened and the fluid can be passed through the first end 111, the rotating valve 20 and the second end 112. As the rotating valve 20 is closed, the flowing channel 110 is blocked and the fluid passed through the first end 111 is blocked to move which cannot be passed through the rotating valve 20 and the second end 112.

The rotating valve 20 has a passing channel 200, wherein the rotating valve 20 is rotatably mounted on the flowing channel 110 of the 10, so that the rotating valve 20 is capable of being in a first position 201 and in a second position 202. As in the first position 201, the passing channel 200 of the rotating valve 20 is aligned to the 110. As the second position 202, the passing channel 200 of the rotating valve 20 is stagger against with the flowing channel 110.

Furthermore, the rotating valve 20 comprises a main body 21, a driving handle 22 and a fastening arrangement 23, wherein the main body 21 is fastened on the valve end 12 of the tube body 10 by the fastening arrangement 23, wherein the driving handle 22 is mounted on the main body 21 by the fastening arrangement 23 which can be changed the main body 21 by operating the driving handle 22. The main body 21 is disposed in the receiving portion 121 of the valve end 12. The state of open or close of the flowing channel 110 is decided by the position of the main body 21. What is more, by operating the driving handle 22 can change the flowing channel 110 to be opened or closed to control the amount of the fluid. The driving handle 22 and the main body 21 is stable with each other and consistent in movement and stress condition.

The main body 21 further comprises a ball valve 211 and two ball seats 212 in the embodiment. The ball seats 212 are fixed on the two sides of the ball valve 211. By rotating the main body 21, the ball valve 211 and the ball seats 212 are communicated to open the flowing channel 110. By rotating the main body 21, the ball valve 211 and the ball seats 212 can be disconnected to close the flowing channel 10. Thus, by rotating the main body 21, the amount of the fluid can be limited by the ball valve 211. In other words, when the main body 21 of the rotating valve 20 is rotated by the driving handle 22 towards to be opened, the flowing channel 110 is opened with the fluid passing through the first end 111, the ball seats 212 and the ball valve 211 of the rotating valve 20 and the second end 112. When the main body 21 of the rotating valve 20 is rotated by the driving handle 22 towards to be closed, the flowing channel 110 is closed with the fluid passed through the first end 111 stopped by the ball valve 211 which cannot be passed through the ball seats 212 and the ball valve 211 of the rotating valve 20 and the second end 112.

According to the embodiment of the present invention, the ball valve 211 is sealedly mounted on the receiving portion 211 by the fastening arrangement 23. In details, the fastening arrangement 23 includes at least on sealing ring to seal the ball valve 211 in the embodiment.

According to the embodiment, the locking arrangement 30 is disposed between the driving handle 22 and the valve end 12. By limiting the movement of the driving handle 22, the operation on the main body 21 can be limited. Since the fluid can put force to the main body 21 which is conducted to the driving handle 22, the limitation on the driving handle 22 also works on the main body 21. Thus, when the movement of the driving handle 22 is locked, the main body 21 can be hardly to move by the pressure of the fluid.

It is worth to notice that the state of the main body 21 of the rotating valve 20(open or close) is unrelated to the state of the locking arrangement 30 locking or unlocking the rotating valve 20. When the main body 21 is in the moving state 303, the main body 21 can be operated by the driving handle 22 to adjust the flowing channel 10. When the main body 21 is in the stopping state 304, the main body 21 cannot be operated by the driving handle 22 to change the state of the main body 21 which sustains the state of the flowing channel 110.

Furthermore, the driving handle 22 further comprises a valve stem 221 and a controlling arm 222. The vale stem 221 is extended from the ball valve 211 which is received in the receiving portion 121. The controlling arm 222 is vertically engaged to the valve stem 221. According to the embodiment, the controlling arm 222 is detachably connected to the valve stem 221. When the controlling arm 222 connected to the valve stem 221, by rotating the controlling arm 222, the valve stem 221 is rotated in self-axis.

In other words, by rotating the controlling arm 222, the ball valve 211 is drove to rotate. One skilled in the art will understand that the controlling arm 222 is easier to rotate the valve stem 211 which provides a larger torque.

According to the embodiment, the valve stem 211 is stably mounted on the ball valve 211 via the fastening arrangement 23. In details, the fastening arrangement 23 further includes a fixing cap to connect the valve stem 211 and the ball valve 211. The ball valve 211 has a driving slot 2111 which is adapted to engage the valve stem 211 into the driving slot 2111. In other words, by operating the controlling arm 222 to make the valve stem 211 to rotate, the ball valve 211 is rotated by the valve stem 211. When the ball valve 211 is rotated, the flowing channel 110 can be operated to be opened and closed. When the main body 21 is in the moving state 303, the ball valve 211 of the main body 21 can be operated by the driving handle 22 to adjust the flowing channel 10. When the main body 21 is in the stopping state 304, the ball valve 211 of the main body 21 cannot be operated by the driving handle 22 to change the state of the main body 21 which sustains the state of the flowing channel 110.

Furthermore, the locking arrangement 30 further comprises a valve coupler 31, a driving coupler 32, a mover 33 and a sealer 34. The valve coupler 31 is arranged on the connecting portion 122 of the valve end 12. The driving coupler 32 is arranged on the controlling arm 22 of the driving handle 22. The valve coupler 31 and the driving coupler 32 are capable of engaging with each other. By the valve coupler 31 connecting with the driving coupler 32, the connecting portion 122 and the controlling arm 222 are connected with each other. In other words, by moving the valve coupler 31 and the driving coupler 32, the position between the connecting portion 122 and the controlling arm 222 is changed correspondingly. The valve coupler 31 and the driving coupler 32 can be engaged to be locked which limits to adjust the position between the valve coupler 31 and the driving coupler 32.

The mover 33 is disposed between the valve coupler 31 and the driving coupler 32 to move the driving coupler 32 against the valve coupler 31 and change the relative position of the valve coupler 31 and the driving coupler 32. The sealer 34 is mounted on the driving coupler 32. The sealer 34 limits the driving coupler 32 on the one end to control the distance between the valve coupler 31 and the driving coupler 32. In application, the valve coupler 31 has relative stability against the connecting portion 122 of the valve end 12. The driving coupler 32 is capable of moving relatively by the mover 33. When the sealer 34 is locked the mover 33 to limit movement, the sealer 34 limits the driving coupler 32 moving towards the valve coupler 31.

As shown in FIG. 3, the connecting portion 122 has a groove to dispose the mover 33. According to the embodiment, the mover 33 is a spring with one end mounted on the connecting portion 122, the other end mounted in the controlling arm 222, so as to adjust the distance of the controlling arm 222 and the connecting portion 122.

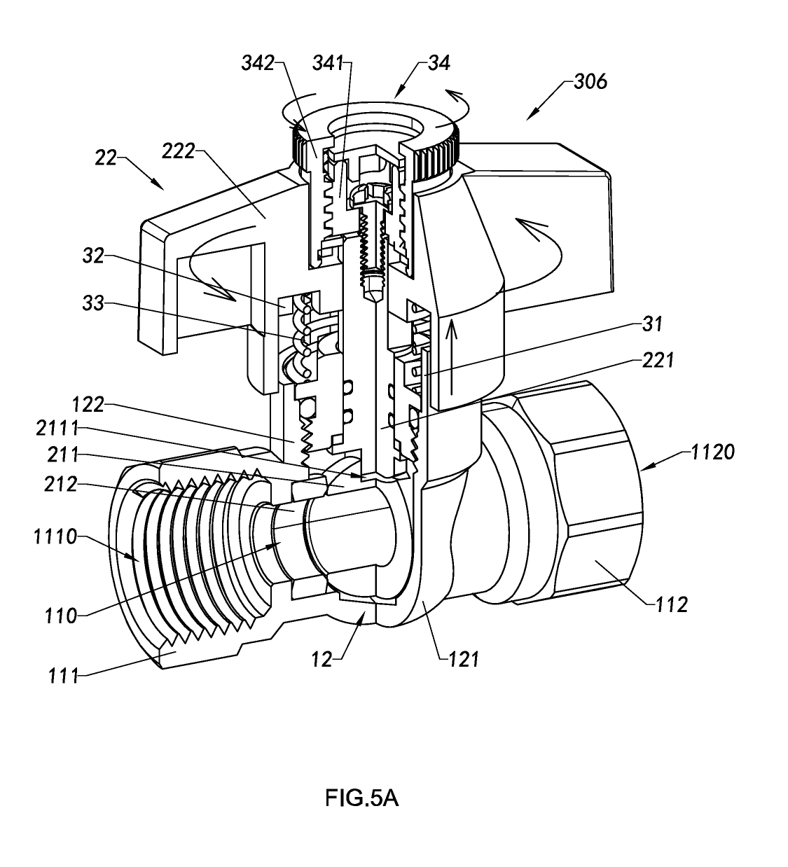

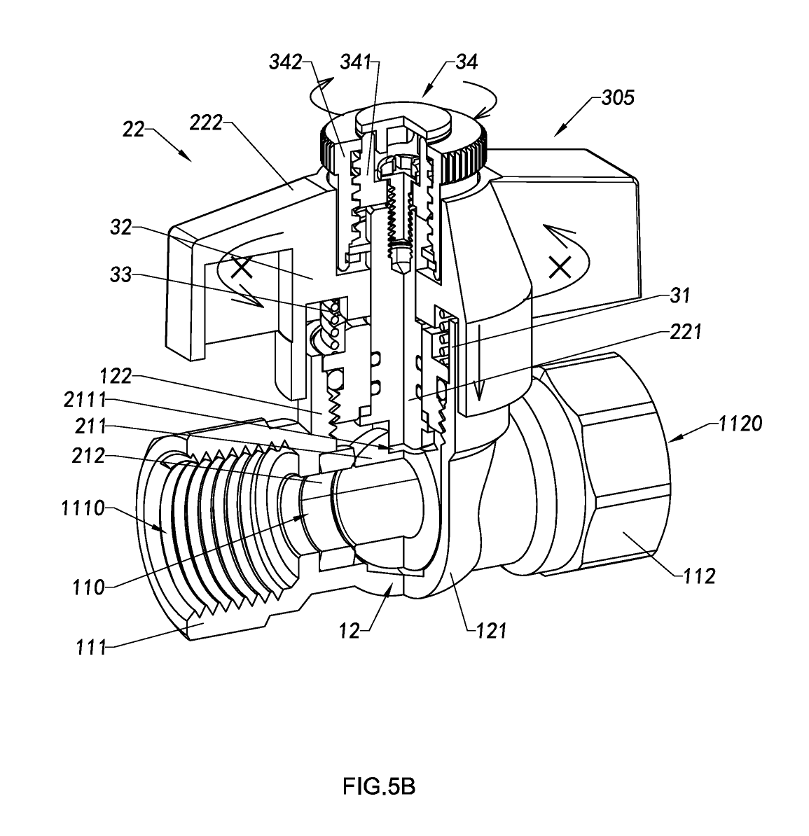

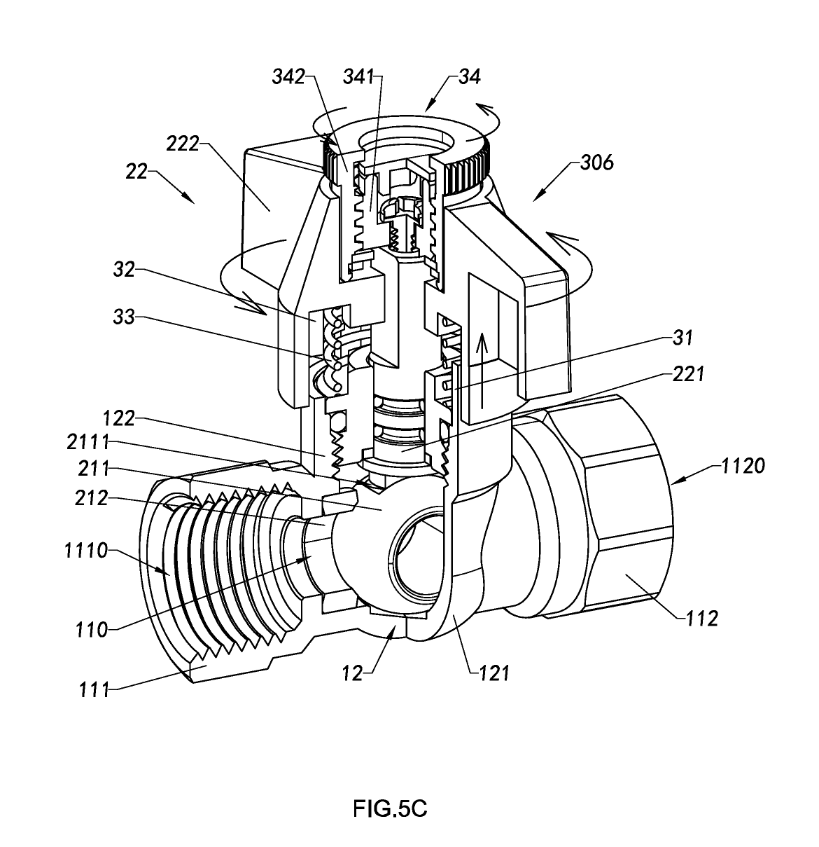

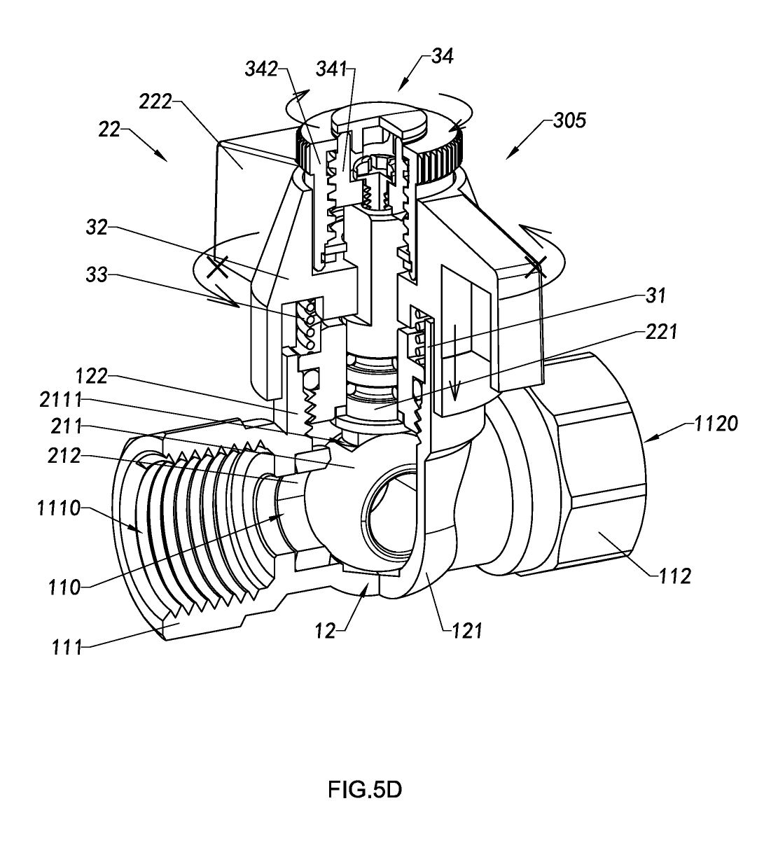

As shown in FIG. 5A to FIG. 5D, the locking arrangement 30 on the rotating valve 20 to lock or unlock is illustrated. The rotating valve 20 is in moving state 303 as in FIG. 5A and FIG. 5C which the rotating valve 20 is unlocked. As in the FIG. 5B and FIG. 5D, the rotating valve 20 is in the stopping state 304.

What is more, the valve coupler 31 and the driving coupler 32 are kept in a certain distance by the mover 33. There is two area of the valve coupler 31 and the driving coupler 32 located. One is stopping area 301 and another is rotating area 302. When the valve coupler 31 and the driving coupler 32 is in the stopping area 301, the valve coupler 31 and the driving coupler 32 are engaged with each other to be locked, and the position of the connecting portion 122 of the valve end 12 and the controlling arm 222 of the driving handle 22 cannot be changed. When the valve coupler 31 and the driving coupler 32 is in the rotating area 302, the valve coupler 31 and the driving coupler 32 are disengaged with each other to be unlocked, and the position of the connecting portion 122 of the valve end 12 and the controlling arm 222 of the driving handle 22 can be changed.

According to the embodiment, the valve coupler 31 are two projections 310 which is approximately symmetrically positioned on the outer side of the connecting portion 122. The driving coupler 32 are two recesses 320 which is positioned correspondingly to the projections 310 on the inner side of the controlling arm 222. When the projections 310 are engaged with the recesses 320, the valve coupler 31 is engaged with the driving coupler 32 which leads to the relative position of the valve coupler 31 and the driving coupler 32 cannot be changed. When the projections 310 are disengaged with the recesses 320, the valve coupler 31 is disengaged with the driving coupler 32 which leads to the relative position of the valve coupler 31 and the driving coupler 32 can be changed.

The position between the controlling arm 222 and the connecting portion 122 is adjustable with the mover 33 moving the valve coupler 31 and the driving coupler 32. In details, when the mover 33 move the controlling arm 222 and the connecting portion 122 to make the projections 310 disengaged with the recesses 320, the valve coupler 31 is movable with the driving coupler 32 which is in the rotating area 302. When the mover 33 move the controlling arm 222 and the connecting portion 122 to make the projections 310 engaged with the recesses 320, the valve coupler 31 is engaged with the driving coupler 32 which is in the stopping area 301.

According to the embodiment, the projections 310 are integrally formed on the connecting portion 122. And the recesses 320 are integrally formed on the inner side of the controlling arm 222.

It is worth to mention that the mover 33 to increase the distance between the valve coupler 31 and the driving coupler 32 for disengaging the projections 310 with the recesses 320. As the mover 33 to decrease the distance between the valve coupler 31 and the driving coupler 32 for engaging the projections 310 with the recesses 320. That is the mover 33 is compressed to be shorter to make the distance between the valve coupler 31 and the driving coupler 32 is decreased and has a trend to be longer like a spring. After back to be longer, the distance between the valve coupler 31 and the driving coupler 32 is increased. In the embodiment, as increasing distance between the valve coupler 31 and the driving coupler 32, it is in the rotating area 302. As decreasing the distance between the valve coupler 31 and the driving coupler 32, it is in the stopping area 301.

What is need to declare that, it is in the rotating area 302 does not mean the rotating valve 20 is in the moving state 303. But it is in the stopping area 301 means that the rotating valve 20 is in the stopping state 304. Since the projections 310 of the valve coupler 31 can be inserted in the recesses 320 of the driving coupler 32, the movement of the valve coupler 31 and the driving coupler 32 is limited. And the controlling arm 222 and the connecting portion 122 are limited to be moved.

Furthermore, the FIG. 5A to 5D are showing the sealer 34 locking and unlocking the rotating valve 20. The sealer 34 further comprises a lock core 341 and a lock cap 342, wherein the lock core 341 is fastened on the valve stem 221 of the controlling arm 22 of the rotating valve 20, wherein the lock core 341 is embedded in the lock cap 342. According to the embodiment, the lock core 341 is fastened by screws on the valve stem 221. Also, to fasten the lock core 341 on the valve stem 221 can use screws, rivets, or molding integrally and so on. The lock cap 342 is capable of moving against the lock core 341 up and down. The lock cap 342 is touched with the controlling arm 222. In other words, as the lock cap 342 is moving down against the lock core 341, the lock cap 342 is forcing to the controlling arm 222. When the controlling arm 222 is forced, the driving coupler 32 on the controlling arm 222 is hardly to move against the valve coupler 31. Especially, as the valve coupler 31 is engaged with the driving coupler 32, the controlling arm 222 is forced to be moved or rotated. When the lock cap 342 is forcing to the controlling arm 222 to block the control handle 22, the sealer 34 of the locking arrangement 30 is in a locking state 305. When the lock cap 342 is weaken forcing to the controlling arm 222 to make the controlling arm 222 movable, the sealer 34 of the locking arrangement 30 is in an unlocking state 306. When the sealer 34 is in the unlocking state 306, the rotating valve 20 is in the moving state 303. When the sealer 34 is in the locking state 305, the rotating valve 20 is in the stopping state 304.

It is worth to mention that the valve coupler 31 and the driving coupler 32 are in the rotating area 302 which is able to be locked by the sealer 34 to make the rotating valve 20 in the stopping state 303. In order to prevent mistake by man-made or pressure of the fluid, the valve coupler 31 and the driving coupler 32 are capable of locking by the sealer 34 even in the stopping area 302 to make the rotating valve 20 in the stopping state 304. Since the projects 310 of the valve coupler 31 can be inserted in the recesses 320 of the driving coupler 32 to be engaged, the relative movement between the valve coupler 31 and the driving coupler 32 is limited. With the pressure of the lock cap 342 on the controlling arm 222, the controlling arm 222 and the connecting portion 122 are not capable of moving against each other.

The lock cap 342 is moved up against the lock core 341 to decrease the force on the controlling arm 222 by the lock cap 342 for unlocking the controlling arm 222. If the valve coupler 31 and the driving coupler 32 are in the stopping area 301, the mover 33 is needed to adjust upward to make the valve coupler 31 and the driving coupler 32 in the rotating area 302 to be in the moving state 303 of the rotating valve 20.

The locking arrangement 30 is capable of limiting the position of the rotating valve 20 by the valve coupler 31, the driving coupler 32 and the sealer 34 to prevent the position of the rotating valve 20 changed by pressure of the fluid. The locking arrangement 30 is limiting the rotating valve 20 in outer side to stay the position of the rotating valve 20 in position. What is more, to unlock the rotating valve 20 by the locking arrangement 30 need at least two steps. The locking arrangement 30 is hardly to be unlocked the stopping state 301 of the rotating valve 20 directly by mistake operation for providing a chance of disoperation.

It is worth to mention that the tube body 10 is pressed in one piece which including the valve coupler 31 on the connecting portion 122. Preferably the tube body 10 is made in cuprum by melting. The driving handle 222 and the driving coupler 32 are made integrally in one piece according to the embodiment, preferably in 3D printing. Also for keeping the water-proof of the tube body 10, the fastening arrangement 23 further comprises at least one spacer to be set in the ball valve 21 and the valve stem 211, the valve stem 211 and the controlling arm 222, or two ends of the mover 33 and so on. One skilled in the art will understand that the fastening arrangement 23 is offering connecting and preventing wear out to stable the whole structure.

Furthermore, the present invention provides a controlling method of the lockable valve, which comprises the steps of:

Unlocking the sealer 34;

Moving the controlling arm 222 to make the distance between the valve coupler 31 and the driving coupler 32 in the rotating area 302;

Rotating the controlling arm 222 to transform the driving handle 22 between the 201 and the 202;

Moving the controlling arm 222 to make the distance between the valve coupler 31 and the driving coupler 32 in the stopping area 301; and

Locking the sealer 34.

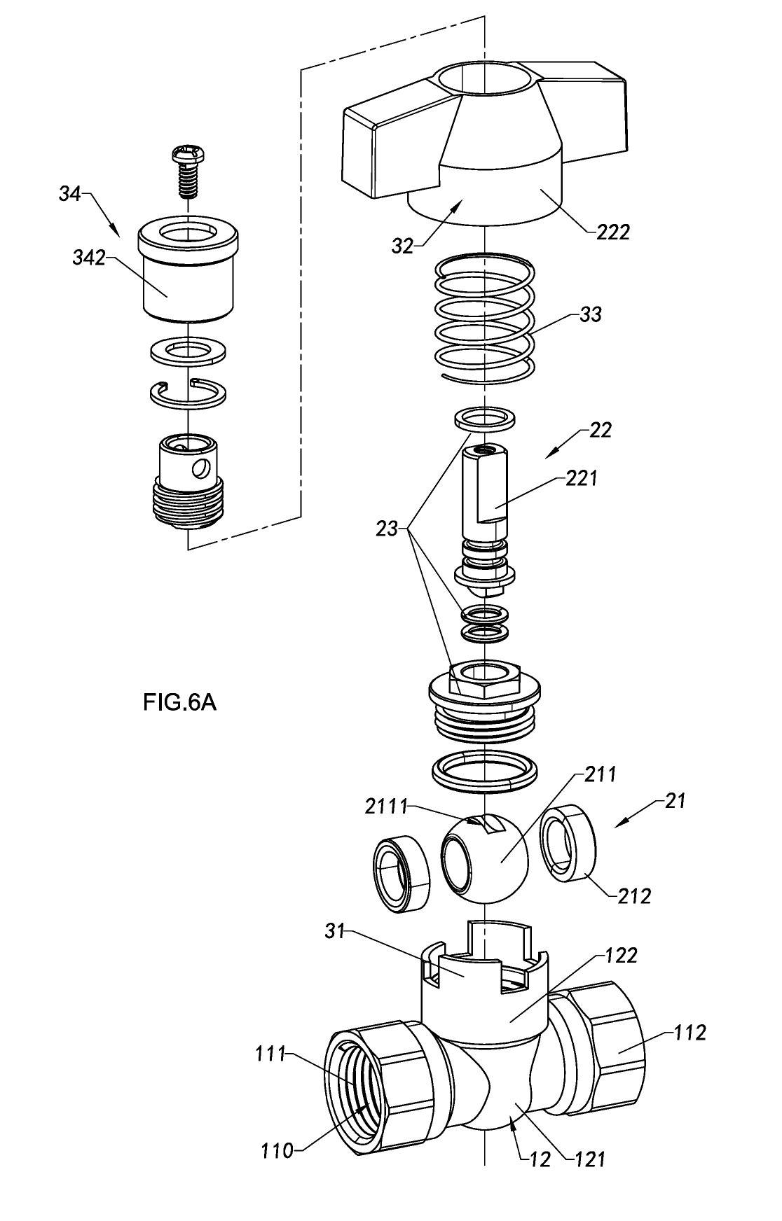

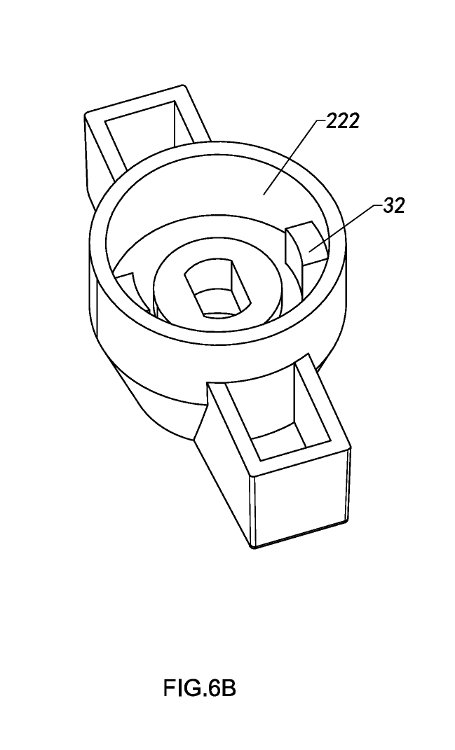

The second embodiment of the present invention is illustrated in FIG. 6A to FIG. 8. The lockable valve comprises a tube body 10A, a rotating valve 20A and a locking arrangement 30B, wherein the tube body 10A and the rotating valve 20A are similar to the tube body 10 and the rotating valve 20 described above in the first embodiment of the present invention which are also functional in the second embodiment.

It is worth to mention that depending on the result operated by the rotating valve 20A, the locking arrangement 30A is capable of limiting the movement of the rotating valve 20A. In other words, the movement of the rotating valve 20A is limited by the locking arrangement 30A which will not be effected by the locking arrangement 30A. The operation to the rotating valve 20A by the movement of the locking arrangement 30A has two states: a moving state 303A and a stopping state 304A. As in the moving state 303A, the rotating valve 20A is capable of moving to operate the tube body 10A from opening to closing or from closing to opening. The locking arrangement 30A is unlocked to limit the rotating valve 20A. As in the stopping state 304A, the rotating valve 20A cannot control the tube body 10A and is limited to be operated form opening to closing or from closing to opening.

The tube body 10A further comprises at least two opening ends 11A and a valve end 12A. The opening end 11A further comprises a first end 111A and a second end 112A. The valve end 12A further comprises a receiving portion 121A and a connecting portion 122A. The rotating valve 20A comprises a main body 21A, a driving handle 22A and a fastening arrangement 23A. The main body 21A further comprises a ball valve 211A and two ball seats 212A. The driving handle 22A further comprises a valve stem 221A and a controlling arm 222A. In other words, the tube body 10B and the rotating valve 20B are similar to the tube body 10 and the rotating valve 20 described above.

Furthermore, the locking arrangement 30A further comprises a valve coupler 31A, a driving coupler 32A, a mover 33A and a sealer 34A. The valve coupler 31A is arranged on the connecting portion 122A of the valve end 12A. The driving coupler 32A is arranged on the controlling arm 222A of the driving handle 22A. The valve coupler 31A and the driving coupler 32A are capable of engaging with each other. By the valve coupler 31A connecting with the driving coupler 32A, the connecting portion 122A and the controlling arm 222A are connected with each other. In other words, by moving the valve coupler 31A and the driving coupler 32A, the position between the connecting portion 122A and the controlling arm 222A is changed correspondingly. The valve coupler 31A and the driving coupler 32A can be engaged to be locked which limits to adjust the position between the valve coupler 31A and the driving coupler 32A.

The mover 33A is disposed between the valve coupler 31A and the driving coupler 32A to move the driving coupler 32A against the valve coupler 31A and change the relative position of the valve coupler 31A and the driving coupler 32A. The sealer 34A is mounted on the driving coupler 32A. The sealer 34A limits the driving coupler 32A on the one end to control the distance between the valve coupler 31A and the driving coupler 32A. In application, the valve coupler 31A has relative stability based on the connecting portion 122A of the valve end 12A. The driving coupler 32A is capable of moving relatively by the mover 33A. When the sealer 34A is locked the mover 33A to limit movement, the sealer 34A limits the driving coupler 32A moving towards the valve coupler 31A. The connecting portion 122A has a groove to dispose the mover 33A. According to the embodiment, the mover 33A is a spring with one end mounted on the connecting portion 122A, the other end mounted in the controlling arm 222A, so as to adjust the distance of the controlling arm 222A and the connecting portion 122A.

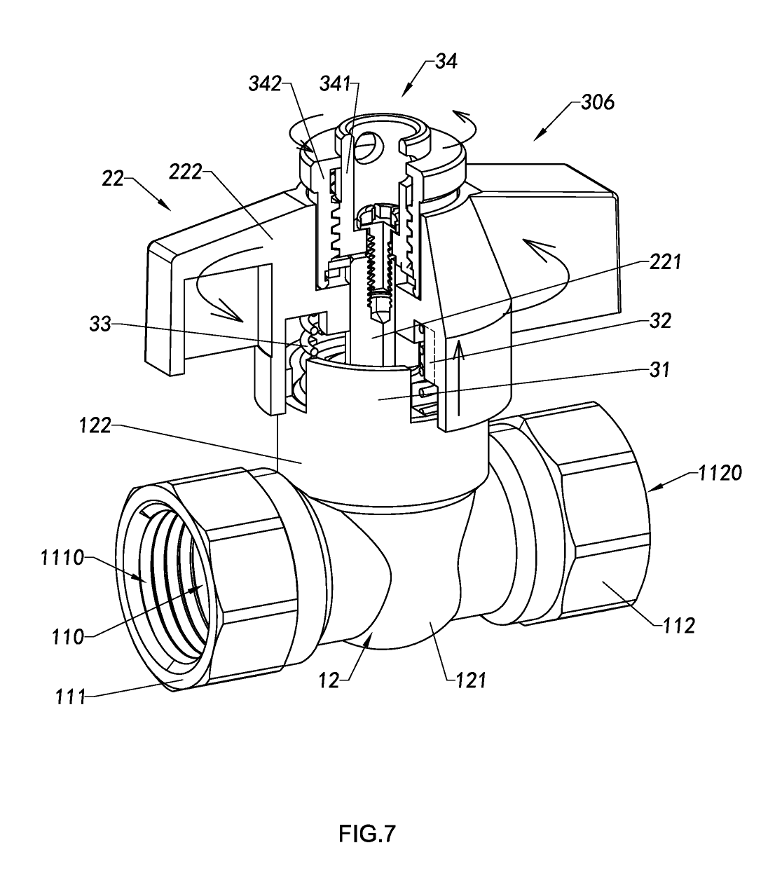

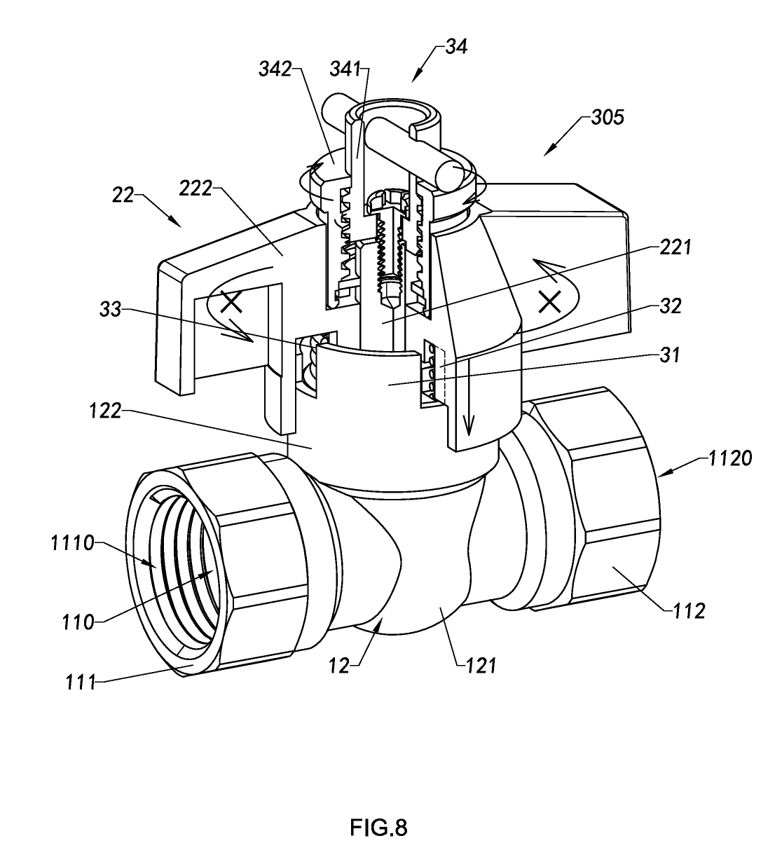

As shown in FIG. 7 to FIG. 8, the locking arrangement 30A on the rotating valve 20A to lock or unlock is illustrated. The rotating valve 20A is in moving state 303A as in FIG. 8 which the rotating valve 20A is unlocked. As in the FIG. 7, the rotating valve 20A is in the stopping state 304A.

What is more, the valve coupler 31A and the driving coupler 32A are kept in a certain distance by the mover 33A. There is two area of the valve coupler 31A and the driving coupler 32A located. One is stopping area 301A and another is rotating area 302A. When the valve coupler 31A and the driving coupler 32A is in the stopping area 301A, the valve coupler 31A and the driving coupler 32A are engaged with each other to be locked, and the position of the connecting portion 122A of the valve end 12A and the controlling arm 222A of the driving handle 22A cannot be changed. When the valve coupler 31A and the driving coupler 32A is in the rotating area 302A, the valve coupler 31A and the driving coupler 32A are disengaged with each other to be unlocked, and the position of the connecting portion 122A of the valve end 12A and the controlling arm 222A of the driving handle 22A can be changed.

According to the embodiment, the valve coupler 31A are four recesses 310A which is approximately symmetrically positioned on the outer side of the connecting portion 122A. The driving coupler 32A are four projections 320A which is positioned correspondingly to the recesses 310A on the inner side of the controlling arm 222A. When the recesses 310A are engaged with the projections 320A, the valve coupler 31A is engaged with the driving coupler 32A which leads to the relative position of the valve coupler 31A and the driving coupler 32A cannot be changed. When the recesses 310A are disengaged with the projections 320A, the valve coupler 31A is disengaged with the driving coupler 32A which leads to the relative position of the valve coupler 31A and the driving coupler 32A can be changed. According to the embodiment, the recesses 310A are integrally formed on the connecting portion 122A. And the projections 320A are integrally formed on the inner side of the controlling arm 222A.

The position between the controlling arm 222A and the connecting portion 122A is adjustable with the mover 33A moving the valve coupler 31A and the driving coupler 32A. In details, when the mover 33A move the controlling arm 222A and the connecting portion 122A to make the recesses 310A disengaged with the projections 320A, the valve coupler 31A is movable with the driving coupler 32A which is in the rotating area 302A. When the mover 33A move the controlling arm 222A and the connecting portion 122A to make the recesses 310A engaged with the projections 320A, the valve coupler 31A is engaged with the driving coupler 32A which is in the stopping area 301A.

It is worth to mention that the mover 33A to increase the distance between the valve coupler 31A and the driving coupler 32A for disengaging the recesses 310A with the projections 320A. As the mover 33A to decrease the distance between the valve coupler 31A and the driving coupler 32A for engaging the recesses 310A with the projections 320A. That is the mover 33A is compressed to be shorter to make the distance between the valve coupler 31A and the driving coupler 32A is decreased and has a trend to be longer like a spring. After back to be longer, the distance between the valve coupler 31A and the driving coupler 32A is increased. In the embodiment, as increasing distance between the valve coupler 31A and the driving coupler 32A, it is in the rotating area 302A. As decreasing the distance between the valve coupler 31A and the driving coupler 32A, it is in the stopping area 301A.

Furthermore, the FIG. 7 and FIG. 8 are showing the sealer 34A locking and unlocking the rotating valve 20A. The sealer 34A further comprises a lock core 341A and a lock cap 342A, wherein the lock core 341A is fastened on the valve stem 221A of the controlling arm 22A of the rotating valve 20A, wherein the lock core 341A is embedded in the lock cap 342A. According to the embodiment, the lock core 341A is fastened by screws on the valve stem 221A. Also, to fasten the lock core 341A on the valve stem 221A can use screws, rivets, or molding integrally and so on. The lock cap 342A is capable of moving against the lock core 341 up and down. The lock cap 342A is touched with the controlling arm 222A. In other words, as the lock cap 342A is moving down against the lock core 341A, the lock cap 342A is forcing to the controlling arm 222A.

When the controlling arm 222A is forced, the driving coupler 32A on the controlling arm 222A is hardly to move against the valve coupler 31A. Especially, as the valve coupler 31A is engaged with the driving coupler 32A, the controlling arm 222A is forced to be moved or rotated. When the lock cap 342A is forcing to the controlling arm 222A to block the control handle 22A, the sealer 34A of the locking arrangement 30A is in a locking state 305A. When the lock cap 342A is weaken forcing to the controlling arm 222A to make the controlling arm 222A movable, the sealer 34A of the locking arrangement 30A is in an unlocking state 306A. When the sealer 34A is in the unlocking state 306A, the rotating valve 20A is in the moving state 303A. When the sealer 34A is in the locking state 305A, the rotating valve 20A is in the stopping state 304A.

It is worth to mention that the lock core 341A has a hole 3410A. When the lock cap 342A is moving down against the lock core 341A, the hole 3410A is exposed to be able to be inserted. When the lock cap 342A is moving towards down to the lock core 341A, the hole 3410A is blocked by the lock cap 342A. The sealer 34A is in the locking state 305A to expose the hole 3420A. The sealer 34A further comprises an inserter 343A, wherein the inserter 342A is adapted to insert into the hole 3410A to stop the lock cap 342A moving upwards. As the inserter 342A is inserting in the hole 3410A on the lock core 341A, the lock cap 342A cannot move upwards to sustain the locking state 305A. Thus, in order to unlock the lock cap 342A, the inserter 342A is needed to be removed to expose the hole 3410A. The lock cap 342A is moved up against the lock core 341A to decrease the force on the controlling arm 222A by the lock cap 342A for unlocking the controlling arm 222A. If the valve coupler 31A and the driving coupler 32A are in the stopping area 301A, the mover 33A is needed to adjust upward to make the valve coupler 31A and the driving coupler 32A in the rotating area 302A to be in the moving state 303A of the rotating valve 20A.

The locking arrangement 30A is capable of limiting the position of the rotating valve 20A by the valve coupler 31A, the driving coupler 32A and the sealer 34A to prevent the position of the rotating valve 20A changed by pressure of the fluid. The locking arrangement 30A is limiting the rotating valve 20A in outer side to stay the position of the rotating valve 20A in position. What is more, to unlock the rotating valve 20A by the locking arrangement 30A need at least two steps. The locking arrangement 30A is hardly to be unlocked the stopping state 301A of the rotating valve 20A directly by mistake operation for providing a chance of disoperation.

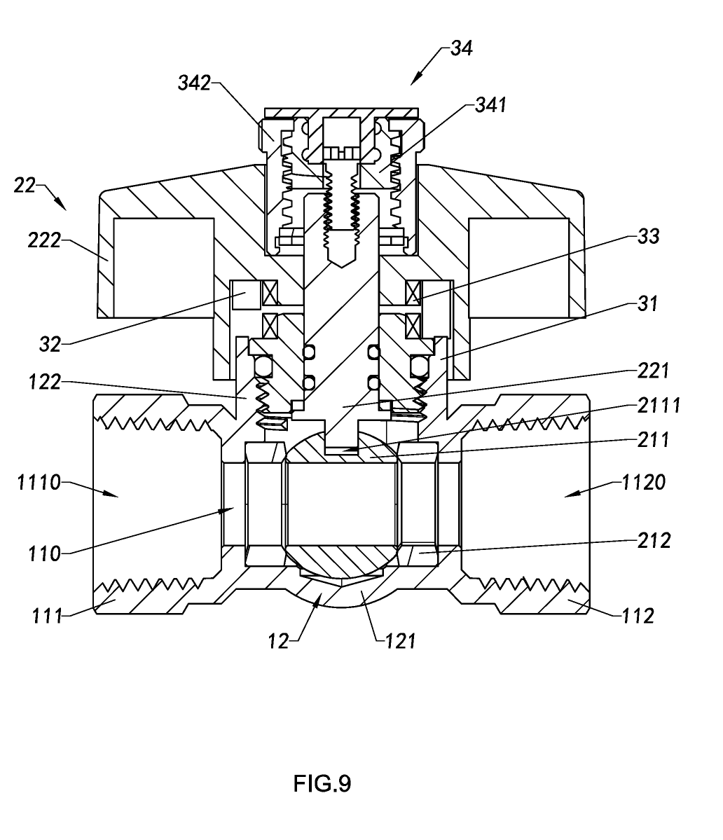

The third embodiment of the present invention is illustrated in FIG. 9 to FIG. 11. The lockable valve comprises a tube body 10B, a rotating valve 20B and a locking arrangement 30B, wherein the tube body 10B and the rotating valve 20B are similar to the tube body 10 and the rotating valve 20 described above in the first embodiment of the present invention which are also functional in the third embodiment.

It is worth to mention that depending on the result operated by the rotating valve 20B, the locking arrangement 30B is capable of limiting the movement of the rotating valve 20B. In other words, the movement of the rotating valve 20B is limited by the locking arrangement 30B which will not be effected by the locking arrangement 30B. The movement of the locking arrangement 30B operating to the rotating valve 20B has two states: a moving state 303B and a stopping state 304B. As in the moving state 303B, the rotating valve 20B is capable of moving to operate the tube body 10B from opening to closing or from closing to opening. The locking arrangement 30B is unlocked to limit the rotating valve 20B. As in the stopping state 304B, the rotating valve 20B cannot control the tube body 10B and is limited to be operated form opening to closing or from closing to opening. The locking arrangement 30B is operated to limit the movement of the rotating valve 20B. The rotating valve 20B controls the fluid to be in a predetermined flow rate in the tube body 10B and the rotating valve 20B is relatively closed with the tube body 10B which cannot be operated actively or passively and need to be unlocked by the locking arrangement 30B to be movable.

The tube body 10B further comprises at least two opening ends 11B and a valve end 12B. The opening end 11B further comprises a first end 111B and a second end 112B. The valve end 12B further comprises a receiving portion 121B and a connecting portion 122B. The rotating valve 20B comprises a main body 21B, a driving handle 22B and a fastening arrangement 23B. The main body 21B further comprises a ball valve 211B and two ball seats 212B. The driving handle 22B further comprises a valve stem 221B and a controlling arm 222B. In other words, the tube body 10B and the rotating valve 20B are similar to the tube body 10 and the rotating valve 20 described above.

Furthermore, the locking arrangement 30B further comprises a valve coupler 31B, a driving coupler 32B, a mover 33B and a sealer 34B. The valve coupler 31B is arranged on the connecting portion 122B of the valve end 12B. The driving coupler 32B is arranged on the controlling arm 22B of the driving handle 22B. The valve coupler 31B and the driving coupler 32B are capable of engaging with each other. By the valve coupler 31B connecting with the driving coupler 32B, the connecting portion 122B and the controlling arm 222B are connected with each other. In other words, by moving the valve coupler 31B and the driving coupler 32B, the position between the connecting portion 122B and the controlling arm 222B is changed correspondingly. The valve coupler 31B and the driving coupler 32B can be engaged to be locked which limits to adjust the position between the valve coupler 31B and the driving coupler 32B.

The mover 33B is disposed between the valve coupler 31B and the driving coupler 32B to move the driving coupler 32B against the valve coupler 31B and change the relative position of the valve coupler 31B and the driving coupler 32B. The sealer 34B is mounted on the driving coupler 32B. The sealer 34B limits the driving coupler 32B on the one end to control the distance between the valve coupler 31B and the driving coupler 32B. In application, the valve coupler 31B has relative stability against the connecting portion 122B of the valve end 12B. The driving coupler 32B is capable of moving relatively by the mover 33B. When the sealer 34B is locked the mover 33B to limit movement, the sealer 34 limits the driving coupler 32B moving towards the valve coupler 31B.

The connecting portion 122B has a groove to dispose the mover 33B. According to the embodiment, the mover 33B is a magnetic spring (a pair of homopolar magnet) with one magnet mounted on the connecting portion 122B, the other magnet mounted in the controlling arm 222B, so as to adjust the distance of the controlling arm 222B and the connecting portion 122B.

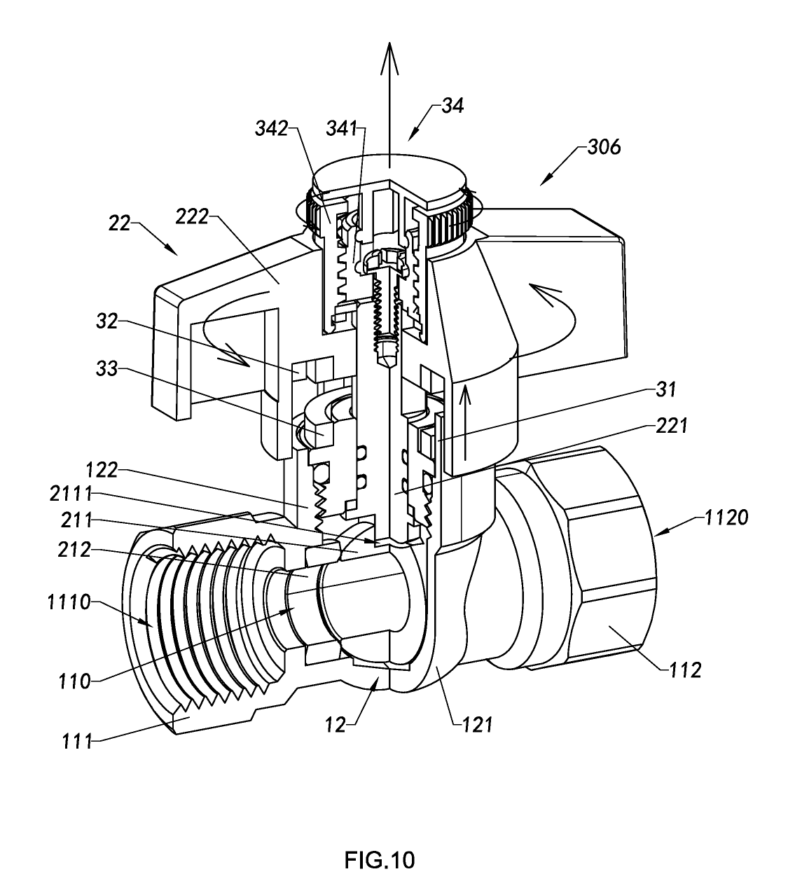

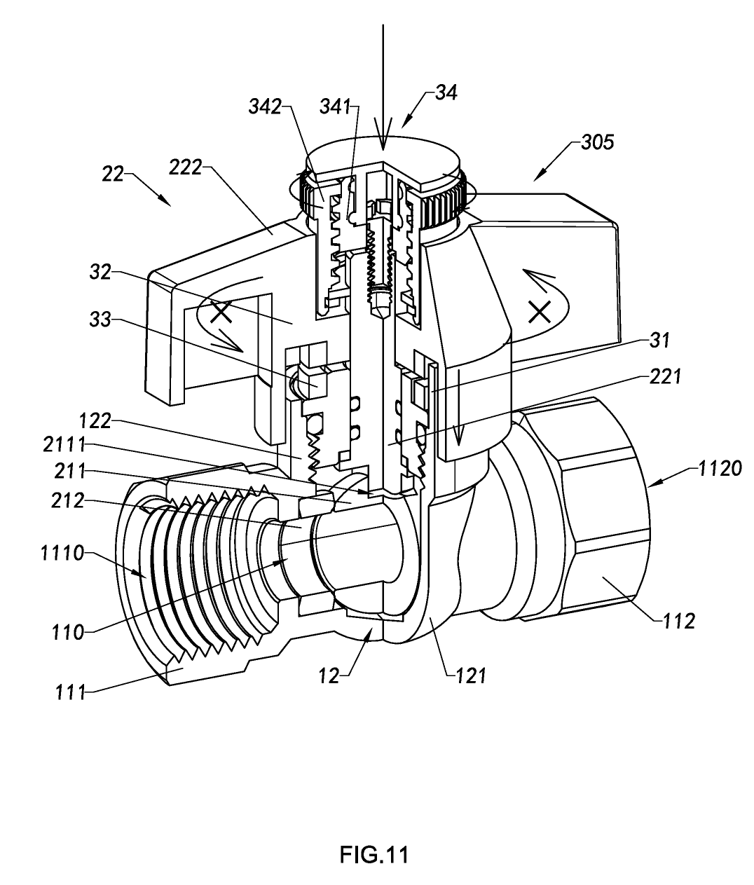

As shown in FIG. 10 to FIG. 11, the locking arrangement 30B on the rotating valve 20B to lock or unlock is illustrated. The rotating valve 20B is in moving state 303B as in FIG. 10 which the rotating valve 20B is unlocked. As in the FIG. 11, the rotating valve 20B is in the stopping state 304B.

What is more, the valve coupler 31B and the driving coupler 32B are kept in a certain distance by the mover 33B. There is two area of the valve coupler 31B and the driving coupler 32B located. One is stopping area 301B and another is rotating area 302B. When the valve coupler 31B and the driving coupler 32B is in the stopping area 301B, the valve coupler 31B and the driving coupler 32B are engaged with each other to be locked, and the position of the connecting portion 122B of the valve end 12B and the controlling arm 222B of the driving handle 22B cannot be changed. When the valve coupler 31B and the driving coupler 32B is in the rotating area 302B, the valve coupler 31B and the driving coupler 32B are disengaged with each other to be unlocked, and the position of the connecting portion 122B of the valve end 12B and the controlling arm 222B of the driving handle 22B can be changed.

According to the embodiment, the valve coupler 31B are two projections 310B which is approximately symmetrically positioned on the outer side of the connecting portion 122B. The driving coupler 32B are two recesses 320B which is positioned correspondingly to the projections 310B on the inner side of the controlling arm 222B. When the projections 310B are engaged with the recesses 320B, the valve coupler 31B is engaged with the driving coupler 32B which leads to the relative position of the valve coupler 31B and the driving coupler 32B cannot be changed. When the projections 310B are disengaged with the recesses 320B, the valve coupler 31B is disengaged with the driving coupler 32B which leads to the relative position of the valve coupler 31B and the driving coupler 32B can be changed.

The position between the controlling arm 222B and the connecting portion 122B is adjustable with the mover 33B moving the valve coupler 31B and the driving coupler 32B. In details, when the mover 33B move the controlling arm 222B and the connecting portion 122B to make the projections 310B disengaged with the recesses 320B, the valve coupler 31B is movable with the driving coupler 32B which is in the rotating area 302B. When the mover 33B move the controlling arm 222B and the connecting portion 122 to make the projections 310B engaged with the recesses 320B, the valve coupler 31B is engaged with the driving coupler 32B which is in the stopping area 301B. According to the embodiment, the projections 310B are integrally formed on the connecting portion 122B. And the recesses 320B are integrally formed on the inner side of the controlling arm 222B.

It is worth to mention that the mover 33B to increase the distance between the valve coupler 31B and the driving coupler 32B for disengaging the projections 310B with the recesses 320B. As the mover 33B to decrease the distance between the valve coupler 31B and the driving coupler 32B for engaging the projections 310B with the recesses 320B. That is the mover 33B is compressed to be shorter to make the distance between the valve coupler 31B and the driving coupler 32B is decreased and has a trend to be longer because of the magnetic levitation force. After back to be longer, the distance between the valve coupler 31B and the driving coupler 32B is increased. In the embodiment, as increasing distance between the valve coupler 31B and the driving coupler 32B, it is in the rotating area 302B. As decreasing the distance between the valve coupler 31B and the driving coupler 32B, it is in the stopping area 301B.

Furthermore, the FIG. 10 and FIG. 11 are showing the sealer 34B locking and unlocking the rotating valve 20B. The sealer 34B further comprises a lock core 341B and a lock cap 342B, wherein the lock core 341B is fastened on the valve stem 221B of the controlling arm 22B of the rotating valve 20B, wherein the lock core 341B is embedded in the lock cap 342B. According to the embodiment, the lock core 341B is fastened by screws on the valve stem 221B. Also, to fasten the lock core 341B on the valve stem 221B can use screws, rivets, or molding integrally and so on. The lock cap 342B is capable of moving against the lock core 341B up and down. The lock cap 342B is touched with the controlling arm 222B. In other words, as the lock cap 342B is moving down against the lock core 341B, the lock cap 342B is forcing to the controlling arm 222B.

When the controlling arm 222B is forced, the driving coupler 32B on the controlling arm 222B is hardly to move against the valve coupler 31B. Especially, as the valve coupler 31B is engaged with the driving coupler 32B, the controlling arm 222B is forced to be moved or rotated. When the lock cap 342B is forcing to the controlling arm 222B to block the control handle 22B, the sealer 34B of the locking arrangement 30 is in a locking state 305B. When the lock cap 342B is weaken forcing to the controlling arm 222B to make the controlling arm 222B movable, the sealer 34 of the locking arrangement 30B is in an unlocking state 306B. When the sealer 34B is in the unlocking state 306B, the rotating valve 20B is in the moving state 303B. When the sealer 34B is in the locking state 305B, the rotating valve 20B is in the stopping state 304B.

The sealer 34B further comprises a locking bottom 3410B. The locking bottom 3410B is mounted on the lock cap 342B to block the movement of the lock cap 342B. The locking bottom 3410B is a resilience bottom to stop the movement of the lock cap 342B towards the lock core 341B. When the locking bottom 3410B is not pressed, the lock cap 342B is moved up against the lock core 341B to decrease the force on the controlling arm 222B by the lock cap 342B for unlocking the controlling arm 222B. If the valve coupler 31 and the driving coupler 32B are in the stopping area 301B, the mover 33B is needed to adjust upward to make the valve coupler 31B and the driving coupler 32B in the rotating area 302B to be in the moving state 303B of the rotating valve 20B.

The locking arrangement 30B is capable of limiting the position of the rotating valve 20B by the valve coupler 31B, the driving coupler 32B and the sealer 34B to prevent the position of the rotating valve 20B changed by pressure of the fluid. The locking arrangement 30B is limiting the rotating valve 20B in outer side to stay the position of the rotating valve 20B in position. What is more, to unlock the rotating valve 20B by the locking arrangement 30B need at least two steps. The locking arrangement 30B is hardly to be unlocked the stopping state 301B of the rotating valve 20B directly by mistake operation for providing a chance of disoperation.

It is worth to mention that the valve coupler 31B and the driving coupler 32B are in the rotating area 302B which is able to be locked by the sealer 34B to make the rotating valve 20B in the stopping state 303B. In order to prevent mistake by man-made or pressure of the fluid, the valve coupler 31B and the driving coupler 32B are capable of locking by the sealer 34B even in the stopping area 302B to make the rotating valve 20B in the stopping state 304B. Since the projects 310B of the valve coupler 31B can be inserted in the recesses 320B of the driving coupler 32B to be engaged, the relative movement between the valve coupler 31B and the driving coupler 32B is limited. With the pressure of the lock cap 342B and the locking bottom 3410B on the controlling arm 222B, the controlling arm 222B and the connecting portion 122B are not capable of moving against each other. With relative to the state of controlling the fluid by the rotating valve, the locking arrangement 30B is focus on controlling the movement of the rotating valve 20B. In a design for locking, it is adaptable to stabilize the states of the lockable valve. For example, the rotating valve 20B controls the fluid to be stopped and closed in the tube body 10B. The locking arrangement 30B is operated to limit the movement of the rotating valve 20B. As the rotating valve 20B is relatively closed with the tube body 10B, the rotating valve 20B is stay in being closed with respect to the rotating valve 20B which cannot be operated actively or passively and need to be unlocked by the locking arrangement 30B to be movable. For example, the rotating valve 20B controls the fluid to be in a predetermined flow rate in the tube body 10B and the rotating valve 20B is relatively closed with the tube body 10B which cannot be operated actively or passively and need to be unlocked by the locking arrangement 30B to be movable.

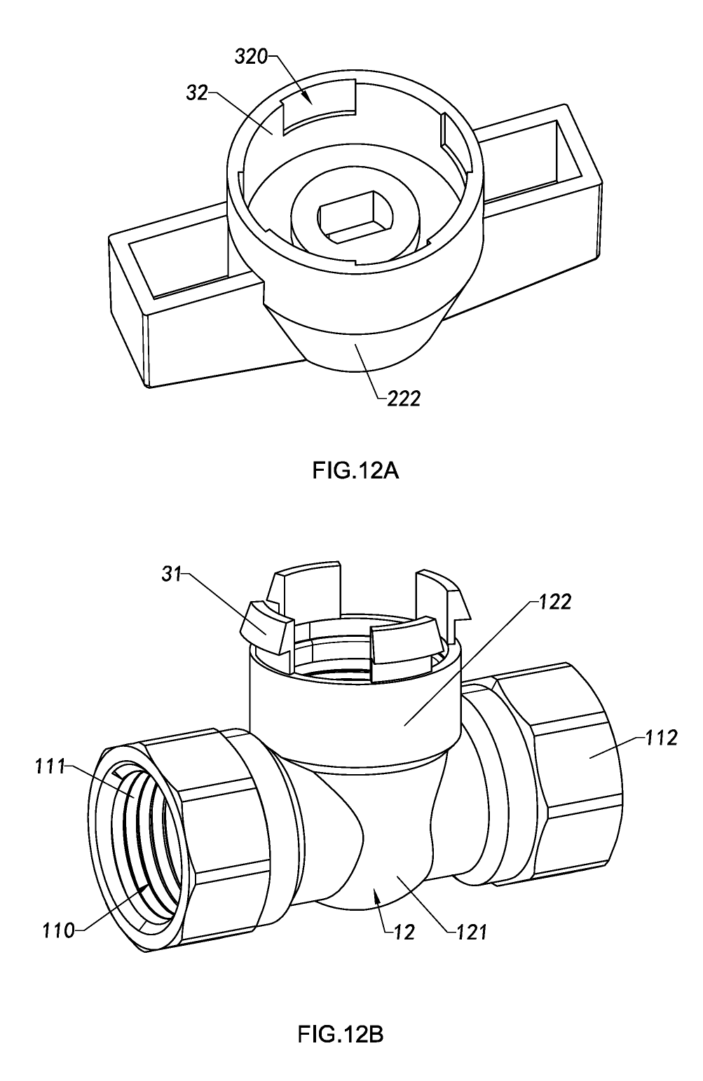

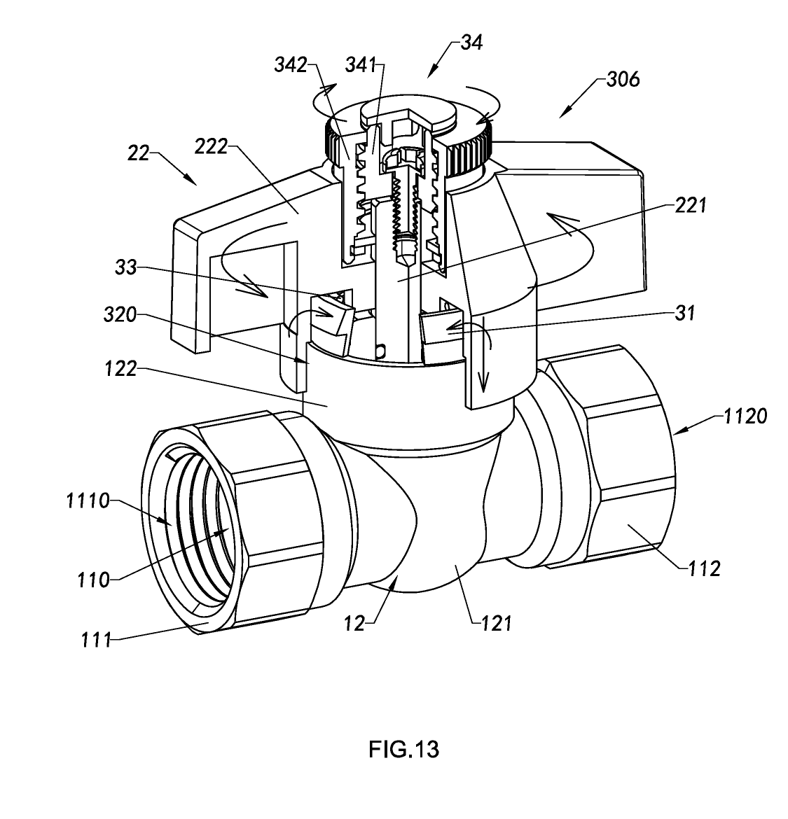

The fourth embodiment of the present invention is illustrated in FIG. 12A to FIG. 16. The lockable valve comprises a tube body 10C, a rotating valve 20C and a locking arrangement 30C, wherein the tube body 10C and the rotating valve 20C are similar to the tube body 10 and the rotating valve 20 described above in the first embodiment of the present invention which are also functional in the third embodiment. It is worth to mention that depending on the result operated by the rotating valve 20C, the locking arrangement 30C is capable of limiting the movement of the rotating valve 20C. In other words, the movement of the rotating valve 20C is limited by the locking arrangement 30C which will not be effected by the locking arrangement 30C.

Therefore, the movement of the locking arrangement 30C operating to the rotating valve 20C has two states: a moving state 303C and a stopping state 304C. As in the moving state 303C, the rotating valve 20C is capable of moving to operate the tube body 10C from opening to closing or from closing to opening. The locking arrangement 30C is unlocked to limit the rotating valve 20C. As in the stopping state 304C, the rotating valve 20C cannot control the tube body 10C and is limited to be operated form opening to closing or from closing to opening. The locking arrangement 30C is operated to limit the movement of the rotating valve 20C. The rotating valve 20C controls the fluid to be in a predetermined flow rate in the tube body 10C and the rotating valve 20C is relatively closed with the tube body 10C which cannot be operated actively or passively and need to be unlocked by the locking arrangement 30C to be movable.

The tube body 10C further comprises at least two opening ends 11C and a valve end 12C. The opening end 11C further comprises a first end 111C and a second end 112C. The valve end 12C further comprises a receiving portion 121C and a connecting portion 122C. The rotating valve 20C comprises a main body 21C, a driving handle 22C and a fastening arrangement 23C. The main body 21C further comprises a ball valve 211C and two ball seats 212C. The driving handle 22C further comprises a valve stem 221C and a controlling arm 222C. In other words, the tube body 10C and the rotating valve 20C are similar to the tube body 10 and the rotating valve 20 described above.

Furthermore, the locking arrangement 30C further comprises a valve coupler 31C, a driving coupler 32C, and a mover 33C. The valve coupler 31C is arranged on the connecting portion 122C of the valve end 12C. The driving coupler 32C is arranged on the controlling arm 22C of the driving handle 22C. The valve coupler 31C and the driving coupler 32C are capable of engaging with each other. By the valve coupler 31C connecting with the driving coupler 32C, the connecting portion 122C and the controlling arm 222C are connected with each other. In other words, by moving the valve coupler 31C and the driving coupler 32C, the position between the connecting portion 122C and the controlling arm 222C is changed correspondingly. The valve coupler 31C and the driving coupler 32C can be engaged to be locked which limits to adjust the position between the valve coupler 31C and the driving coupler 32C.

The mover 33C is disposed between the valve coupler 31C and the driving coupler 32C to move the driving coupler 32C against the valve coupler 31C and change the relative position of the valve coupler 31C and the driving coupler 32C. In application, the valve coupler 31 has relative stability against the connecting portion 122 of the valve end 12C. The driving coupler 32C is capable of moving relatively by the mover 33C. The connecting portion 122C has a groove to dispose the mover 33C. According to the embodiment, the mover 33C is a spring with one end mounted on the connecting portion 122C, the other end mounted in the controlling arm 222C, so as to adjust the distance of the controlling arm 222C and the connecting portion 122C.

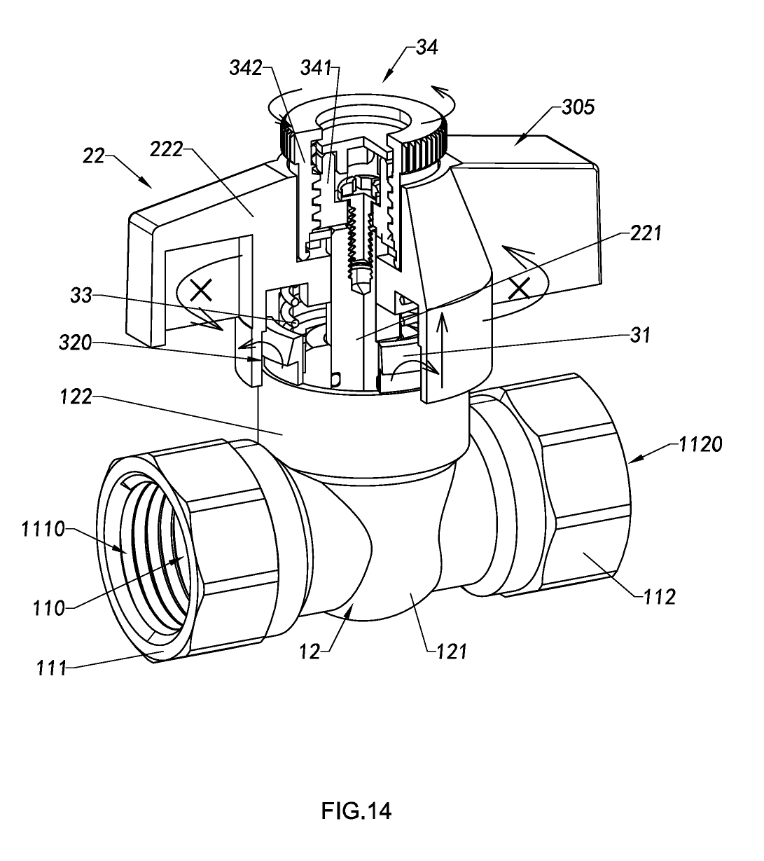

As shown in FIG. 13 to FIG. 14, the locking arrangement 30C on the rotating valve 20C to lock or unlock is illustrated. The rotating valve 20C is in moving state 303C as in FIG. 13 which the rotating valve 20C is unlocked. As in the FIG. 14, the rotating valve 20C is in the stopping state 304C.

What is more, the valve coupler 31C and the driving coupler 32C are kept in a certain distance by the mover 33C. There is two area of the valve coupler 31C and the driving coupler 32C located. One is stopping area 301C and another is rotating area 302C. When the valve coupler 31C and the driving coupler 32C is in the stopping area 301C, the valve coupler 31C and the driving coupler 32C are engaged with each other to be locked, and the position of the connecting portion 122C of the valve end 12C and the controlling arm 222C of the driving handle 22C cannot be changed. When the valve coupler 31C and the driving coupler 32C is in the rotating area 302C, the valve coupler 31C and the driving coupler 32C are disengaged with each other to be unlocked, and the position of the connecting portion 122C of the valve end 12C and the controlling arm 222C of the driving handle 22C can be changed.

According to the embodiment, the valve coupler 31C are two resilient trips 310C which is approximately symmetrically positioned on the outer side of the connecting portion 122C. The driving coupler 32C are two blocker 320C which is positioned correspondingly to the resilient trips 310C on the inner side of the controlling arm 222C. When the resilient trips 310C are engaged with the blocker 320C, the valve coupler 31C is engaged with the driving coupler 32C which leads to the relative position of the valve coupler 31C and the driving coupler 32C cannot be changed. When the resilient trips 310C are disengaged with the blocker 320C, the valve coupler 31C is disengaged with the driving coupler 32C which leads to the relative position of the valve coupler 31C and the driving coupler 32C can be changed.

It is worth to mention that the mover 33C to increase the distance between the valve coupler 31C and the driving coupler 32C for engaging the resilient trips 310C with the blocker 320C. As the mover 33C to decrease the distance between the valve coupler 31C and the driving coupler 32C for disengaging the resilient trips 310C with the blocker 320C. That is the mover 33C is compressed to be shorter to make the distance between the valve coupler 31C and the driving coupler 32C is decreased and has a trend to be longer like a spring. After back to be longer, the distance between the valve coupler 31C and the driving coupler 32C is increased. In the embodiment, as increasing distance between the valve coupler 31C and the driving coupler 32C, it is in the stopping area 301C. As decreasing the distance between the valve coupler 31C and the driving coupler 32C, it is in the rotating area 302C.

The position between the controlling arm 222C and the connecting portion 122C is adjustable with the mover 33C moving the valve coupler 31C and the driving coupler 32C. In details, when the mover 33C move the controlling arm 222C and the connecting portion 122C to make the resilient trips 310C disengaged with the blocker 320C, the valve coupler 31C is movable with the driving coupler 32C which is in the rotating area 302C. When the mover 33C move the controlling arm 222C and the connecting portion 122C to make the resilient trips 310C engaged with the blocker 320C, the valve coupler 31C is engaged with the driving coupler 32C which is in the stopping area 301C. According to the embodiment, the resilient trips 310C are integrally formed on the connecting portion 122C. And the blocker 320C are integrally formed on the inner side of the controlling arm 222C.

In other words, with relative to the state of controlling the fluid by the rotating valve, the locking arrangement 30C is focus on controlling the movement of the rotating valve 20C. In a design for locking, it is adaptable to stabilize the states of the lockable valve. For example, the rotating valve 20C controls the fluid to be stopped and closed in the tube body 10C. The locking arrangement 30C is operated to limit the movement of the rotating valve 20C. As the rotating valve 20C is relatively closed with the tube body 10C, the rotating valve 20C is stay in being closed with respect to the rotating valve 20C which cannot be operated actively or passively and need to be unlocked by the locking arrangement 30C to be movable. For example, the rotating valve 20C controls the fluid to be in a predetermined flow rate in the tube body 10C and the rotating valve 20C is relatively closed with the tube body 10C which cannot be operated actively or passively and need to be unlocked by the locking arrangement 30C to be movable.

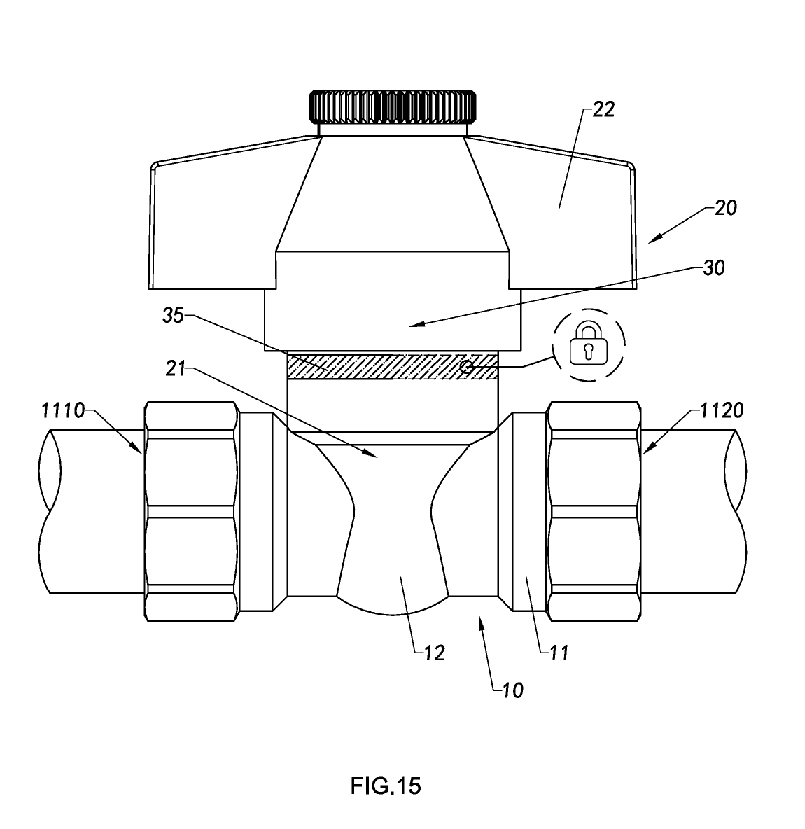

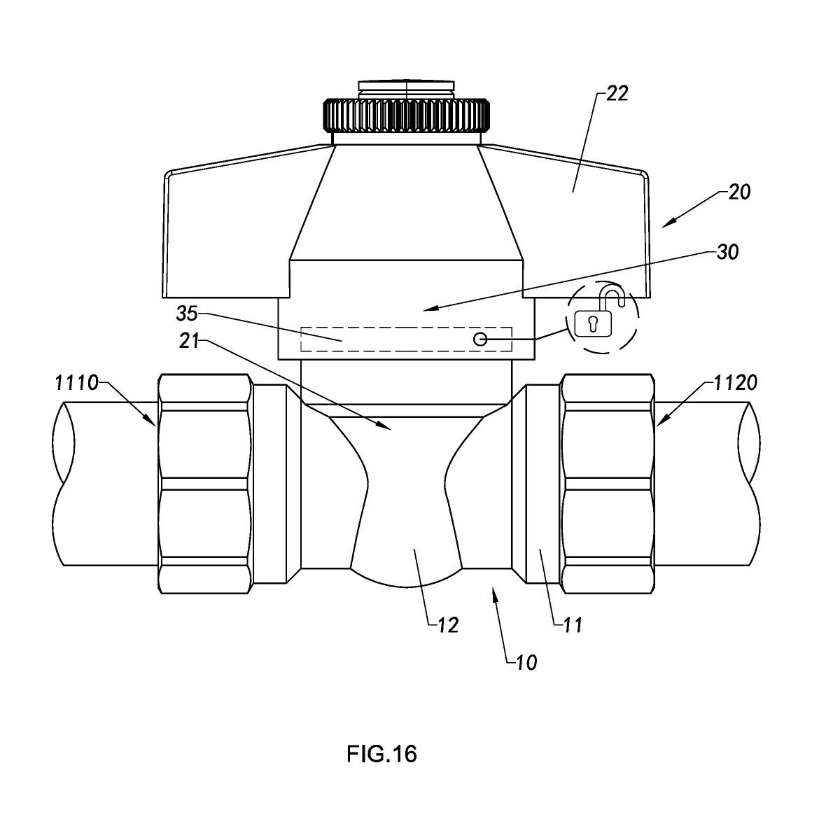

The locking arrangement 30C further comprises a mark 35C, wherein the mark 35C is disposed in the outer side of the connecting portion 122C to indicate the state of the valve coupler 31C and the driving coupler 32C. According to the embodiment, as in FIG. 15 and FIG. 16, the mark 35C is a colored strip drawn on the connecting portion 122C which is capable of being covered by the controlling arm 222C.

As the distance between the valve coupler 31C and the driving coupler 32C is increased to be in the stopping area 301C, the mark 35C is shown. As the distance between the valve coupler 31C and the driving coupler 32C is decreased, the mark 35C is covered completely. In other words, when the mark 35C cannot be seen, the valve coupler 31C and the driving coupler 32C is in the rotating area 302C. By identifying the mark 35C, the state of the valve coupler 31C and the driving coupler 32C is easy to be known to prevent forgetting to lock the lockable valve or operating locked the lockable valve to damage the structure.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lockable valve, comprising:
a tube body, wherein the tube body further comprises at least two opening ends and a valve end, wherein the valve end is positioned between the at least two opening ends;
a rotating valve, wherein the rotating valve is disposed in the tube body for controlling a fluid flowing through the at least two opening ends of the tube body; and
a locking arrangement, wherein the locking arrangement is arranged on the rotating valve to limit rotation of the rotating valve between a stopping state and a moving state, wherein when the rotating valve is in the stopping state, the rotating valve is blocked to be moved, wherein when the rotating valve is in the rotating state, the rotating valve is unlocked to be moved to adjust the flowing condition of the fluid in the tube body.

2. The lockable valve, as recited in claim 1, wherein the locking arrangement is arranged on the rotating valve against the tube body.

3. The lockable valve, as recited in claim 1, wherein the locking arrangement further comprises a valve coupler, a driving coupler and a mover, wherein the valve coupler and the driving coupler are movable relatively against each other by the mover to change the distance between the valve coupler and the driving coupler.

4. The lockable valve, as recited in claim 3, wherein the valve end further comprises a receiving portion and a connecting portion, wherein the receiving portion is adapted to be mounted the rotating valve therein, wherein the connecting portion is extended integrally from the receiving portion.

5. The lockable valve, as recited in claim 4, wherein the rotating valve further comprises a main body, a driving handle and a fastening arrangement, wherein the main body is mounted in the valve end by the fastening arrangement, wherein the driving handle is mounted on the main body by the fastening arrangement to be rotated to drive the main body to control the fluid in the tube body.

6. The lockable valve, as recited in claim 5, wherein the main body is positioned in the receiving portion of the valve end.

7. The lockable valve, as recited in claim 5, wherein the main body further comprises a ball valve and two ball seats, wherein the ball seats are communicably disposed on the two ends of the valve ball.

8. The lockable valve, as recited in claim 7, wherein the driving handle comprises a valve stem and a controlling arm, wherein the valve stem is extended from the ball valve to drive the ball valve to rotate, wherein the controlling arm is vertically engaged with the valve stem.

9. The lockable valve, as recited in claim 8, wherein the ball valve has a slot, wherein the valve stem is adapted to engage to the slot of the ball valve.

10. The lockable valve, as recited in claim 8, wherein when the rotating valve is in moving state, the ball valve of the main body is operated by the driving handle, wherein when the rotating valve is in stopping state, the ball valve of the main body is limited to be operated by the driving handle.

11. The lockable valve, as recited in claim 8, wherein the valve coupler and the driving coupler is engaged when the distance between the valve coupler and the driving coupler has arrived in a predetermined level.

12. The lockable valve, as recited in claim 11, wherein the valve coupler is disposed in the connecting portion of the valve end, wherein the driving coupler is disposed in the controlling arm.

13. The lockable valve, as recited in claim 11, wherein the distance between the valve coupler and the driving coupler moved by the mover has two areas: a stopping area and a rotating area, wherein when the valve coupler and the driving coupler are in the stopping area, the valve coupler and the driving coupler are engaging with each other, when the valve coupler and the driving coupler are in the rotating area, the valve coupler and the driving coupler are disengaged to be changeable.

14. The lockable valve, as recited in claim 13, wherein the valve coupler and the driving coupler are in the rotating area, the connecting portion of the valve end and the controlling arm of the driving handle are movable to be moved, when the valve coupler and the driving coupler are in stopping area, the connecting portion of the valve end and the controlling arm of the driving handle are lockably limited to be moved.

15. The lockable valve, as recited in claim 13, wherein the distance between the valve coupler and the driving coupler is longer in the stopping area than in the rotating area.

16. The lockable valve, as recited in claim 13, wherein the distance between the valve coupler and the driving coupler is shorter in the stopping area than in the rotating area.

17. The lockable valve, as recited in claim 13, wherein the valve coupler is a plurality of projections which is approximately symmetrically positioned on the outer side of the connecting portion.

18. The lockable valve, as recited in claim 17, wherein the driving coupler is a plurality of recesses which is positioned correspondingly to the projections on the inner side of the controlling arm.

19. The lockable valve, as recited in claim 18, wherein when the projections are engaged with the recesses, the valve coupler is engaged with the driving coupler which leads to the relative position of the valve coupler and the driving coupler is limited to be changed, when the projections are disengaged with the recesses, the valve coupler is disengaged with the driving coupler which leads to the relative position of the valve coupler and the driving coupler can be changed.

20. The lockable valve, as recited in claim 13, wherein the valve coupler is a plurality of recesses which is approximately symmetrically positioned on the outer side of the connecting portion.

21. The lockable valve, as recited in claim 20, wherein the driving coupler is a plurality of projections which is positioned correspondingly to the projections on the inner side of the controlling arm.

22. The lockable valve, as recited in claim 13, wherein the valve coupler is a plurality of resilient trips which is approximately symmetrically positioned on the outer side of the connecting portion, wherein the driving coupler is a plurality of blockers which is positioned correspondingly to the projections on the inner side of the controlling arm.

23. The lockable valve, as recited in claim 13, wherein the locking arrangement further comprises a sealer which is disposed on the driving coupler to lock the movement of the driving coupler against the valve coupler.

24. The lockable valve, as recited in claim 13, wherein the mover is a spring.

25. The lockable valve, as recited in claim 13, wherein the mover is a magnetic spring.

26. The lockable valve, as recited in claim 13, wherein the valve coupler is integrally formed with the connecting portion.

27. The lockable valve, as recited in claim 26, wherein the connecting portion of the tube body and the valve coupler are made in cuprum by melting.

28. The lockable valve, as recited in claim 13, wherein the driving coupler is integrally formed with the controlling arm.

29. The lockable valve, as recited in claim 28, wherein the controlling arm of the driving handle and the driving coupler are made in 3D printing.
